(19) United States
(12) Patent Application Publication
(10) Pub. No.: US 2025/0088042 A1
(43) Pub. Date: Mar. 13, 2025

(54) CHARGING SURFACE ACTIVATED BY PROXIMITY OF AN OBJECT

(71) Applicant: AIRA, INC., Phoenix, AZ (US)

(72) Inventor: Jake Slatnick, San Diego, CA (US)

(21) Appl. No.: 18/826,154

(22) Filed: Sep. 5, 2024

Related U.S. Application Data
(60) Provisional application No. 63/537,198, filed on Sep. 7, 2023.

(51) Int. Cl. H02J 50/90; H02J 50/00; H02J 50/12; H02J 50/40; H02J 50/60

(52) U.S. Cl. CPC H02J 50/90; H02J 50/005; H02J 50/12; H02J 50/402; H02J 50/60

(57) ABSTRACT

A charging system, comprising a charging surface comprising one or more charging areas associated with a wireless charging device, a plurality of power transmitting coils apportioned among the one or more charging areas, and a controller. The controller may be configured to conduct a low-power search of the charging surface to determine if an electrical or magnetic characteristic of two or more power transmitting coils has been affected by an object passing in proximity to the two or more power transmitting coils, determine a geometric relationship between physical locations of the two or more power transmitting coils, and illuminate one or more indicator lines to identify a physical location of a charging area available to wirelessly charge a chargeable device. The physical location may be selected based on the geometric relationship between physical locations of the two or more power transmitting coils.

### PRIORITY CLAIM

This application claims priority to and the benefit of provisional patent application No. 63/537,198 filed in the United States Patent Office on Sep. 7, 2024, the entire content of this application being incorporated herein by reference as if fully set forth below in its entirety and for all applicable purposes.

### TECHNICAL FIELD

The present invention relates generally to charging surfaces for wireless charging of battery-powered devices, and more particularly to activating or indicating a charging surface in a countertop or other surface upon detection of the presence of a device or person.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to provide flexibility in charging configurations and support continually increasing complexity of mobile devices and changing form factors.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates the arrangement of power transfer areas provided by a charging surface that employs multiple layers of charging cells configured in accordance with certain aspects disclosed herein.

FIG. 4 illustrates a first topology that supports matrix multiplexed switching for use in a wireless charging device adapted in accordance with certain aspects disclosed herein.

FIG. 5 illustrates a second topology that supports direct current drive in a wireless charging device adapted in accordance with certain aspects disclosed herein.

FIG. 6 illustrates an example of a modular charging surface provided in accordance with certain aspects disclosed herein.

FIG. 7 illustrates an example of a Litz transmitting coil configured in accordance with certain aspects of this disclosure.

FIG. 8 illustrates an example of a portion of a charging surface provided using multiple overlapping Litz coils in accordance with certain aspects of this disclosure.

FIG. 9 illustrates a charging module in a wireless charging device constructed from Litz coils according to certain aspects of this disclosure.

FIG. 10 illustrates certain aspects of a Litz coil substrate provided in accordance with certain aspects of this disclosure.

FIG. 11 illustrates a wireless transmitter that may be provided in a charger base station in accordance with certain aspects disclosed herein.

FIG. 12 illustrates a response to a passive ping.

FIG. 13 illustrates differences in responses to a passive ping.

FIG. 14 illustrates a method involving passive ping implemented in a wireless charging device adapted in accordance with certain aspects disclosed herein.

FIG. 15 illustrates an example of frequency response obtained when a resonant circuit is stimulated by a ping that includes several cycles of a signal that oscillates at or near the nominal resonant frequency of the resonant circuit.

FIG. 16 illustrates an example of frequency response obtained when a resonant circuit is stimulated by a ping that includes a burst of a stimulation signal that oscillates at a frequency that is greater than the nominal resonant frequency of the resonant circuit.

FIG. 17 illustrates a circuit that can measure response of a resonant circuit in a passive ping procedure.

FIG. 18 is a flowchart that illustrates a power transfer management procedure that may be employed by a wireless charging device implemented in accordance with certain aspects disclosed herein.

FIG. 19 illustrates an example of a charging system that includes multiple charging devices provided in accordance with certain aspects of this disclosure.

FIG. 20 illustrates a first example of a combined control circuit in a modular charging surface provided in accordance with certain aspects disclosed herein.

FIG. 21 illustrates a second example of a combined control circuit that may be provided in a modular charging surface provided according to certain aspects disclosed herein.

FIG. 22 illustrates the use of modular charging devices to provide one or more charging surfaces on an item of furniture in accordance with certain aspects of this disclosure.

FIG. 23 illustrates a configuration of charging areas on a surface configured in accordance with certain aspects of this disclosure.

FIG. 24 illustrates an example of a wireless tag that may be adapted in accordance with certain aspects of this disclosure.

FIG. 25 illustrates an example of a system that includes a wireless charging circuit and one or more Near Field Communication radios.

FIG. 26 is flowchart illustrating an example of a method for operating a charging system in accordance with certain aspects disclosed herein.

FIG. 27 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communication (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Certain aspects of the present disclosure relate to systems, apparatus and methods associated with wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects of the present disclosure relate to systems, apparatus and methods that enable fast, low-power detection of objects placed in proximity to a charging surface. In one example, an object may be detected when a pulse provided to a charging circuit stimulates an oscillation in the charging circuit, or in some portion thereof. A frequency of oscillation of the charging circuit responsive to the pulse or a rate of decay of the oscillation of the charging circuit may be indicative or determinative of presence of a chargeable device has been placed in proximity to a coil of the charging circuit. Identification of a type or nature of the object may be made based on changes in a characteristic of the charging circuit. The pulse provided to the charging circuit may have a duration that is less than half the period of a nominal resonant frequency of the charging circuit.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of a wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

Certain aspects of the present disclosure relate to systems, apparatus and methods for a wireless charging system that provide multiple power transmitting coils in elements of a modular or distributed surface. The coils may be stacked and can be used to charge target devices presented to the wireless charging systems without a requirement to match a particular geometry or location within a charging surface of the charging device. Each coil may have a shape that is substantially polygonal. In one example, each coil may have a hexagonal shape. Each coil may be implemented using wires, printed circuit board traces and/or other connectors that are provided in a spiral. In one example, the coils coil may be implemented using Litz wires. Each coil may span two or more layers separated by an insulator or substrate such that coils in different layers are centered around a common axis.

According to certain aspects disclosed herein, devices placed on a charging surface provided by the wireless charging system may receive power that is wirelessly transmitted through one or more of the charging cells that are associated with the charging surface. Power can be wirelessly transferred to a receiving device located anywhere on the charging surface. The receiving device can have an arbitrarily defined size and/or shape and may be placed without regard to any discrete placement locations enabled for charging. Multiple devices can be simultaneously or concurrently charged on a single surface. The apparatus can track motion of one or more devices across the surface. A charging system may provide multiple charging surface portions that are physically separated from one another but managed as a single modular charging surface that can manage and control simultaneously charging of multiple devices. The charging system may be manufactured at low cost and/or with a compact design.

Certain aspects of this disclosure relate to systems and methods implemented using low power radio frequency (RF) communication. For example, near-field communication (NFC) standards or protocols can be used to operate low-power wireless tags using a small amount of energy incident in a radio frequency (RF) field. In one example, the wireless tag may operate in accordance with a radio-frequency identification (RFID) protocol. The energy used to operate the wireless tag may be extracted from an interrogation signal transmitted by an interrogating device, RFID reader or other device. In one aspect of this disclosure, the mobile device may be configured to operate as an interrogating device. Certain devices constructed according to certain aspects of the presently described invention can be incorporated in, or controlled by wireless charging devices.

According to certain aspects disclosed herein, a charging surface in a wireless charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the charging surface. In this disclosure, a charging cell may refer to an element having one or more coils where each coil is configured to produce an electromagnetic field that is additive with respect to the fields produced by other coils in the charging cell and directed along or proximate to a common axis. In this description, a coil in a charging cell may be referred to as a charging coil or a transmitting coil.

In some examples, a charging cell includes coils that are stacked along a common axis. One or more coils may overlap such that they contribute to an induced magnetic field substantially orthogonal to the charging surface. In some examples, a charging cell includes coils that are arranged within a defined portion of the charging surface and that contribute to an induced magnetic field within the defined portion of the charging surface, the magnetic field contributing to a magnetic flux flowing substantially orthogonal to the charging surface. In some implementations, charging cells may be configurable by providing an activating current to coils that are included in a dynamically-defined charging cell. For example, a wireless charging device may include multiple stacks of coils deployed across a charging surface, and the wireless charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

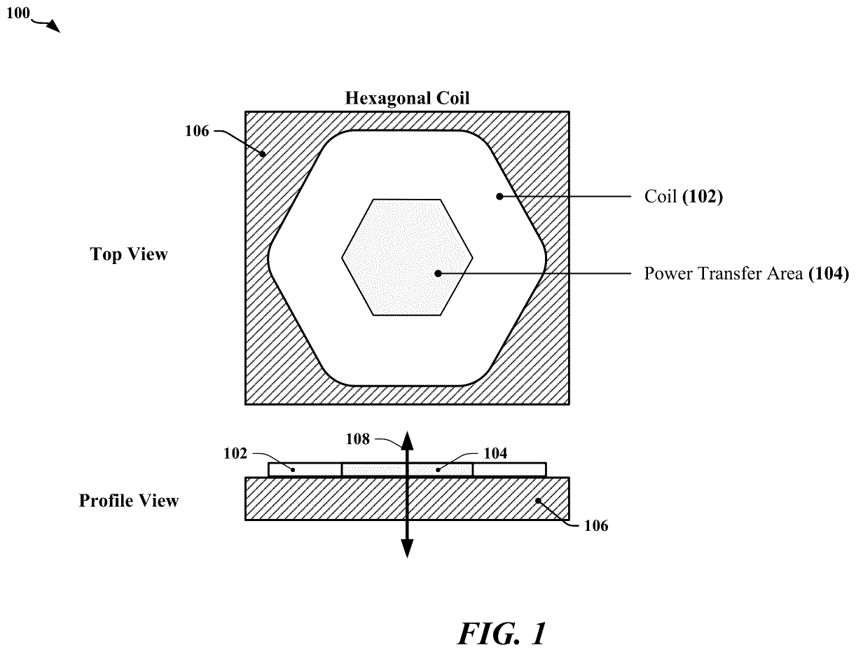

FIG. 1 illustrates an example of a charging cell 100 that may be deployed and/or configured to provide a charging surface in a wireless charging device. In this example, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations may include or use coils 102 that have other shapes. The shape of the coils 102 may be determined at least in part by the capabilities or limitations of fabrication technology or to optimize layout of the charging cells on a substrate 106 such as a printed circuit board substrate. Each coil 102 may be implemented using wires, printed circuit board traces and/or other connectors in a spiral configuration. The wires may comprise Litz wires. Each charging cell 100 may span two or more layers separated by an insulator or substrate 106 such that coils 102 in different layers are centered around a common axis 108.

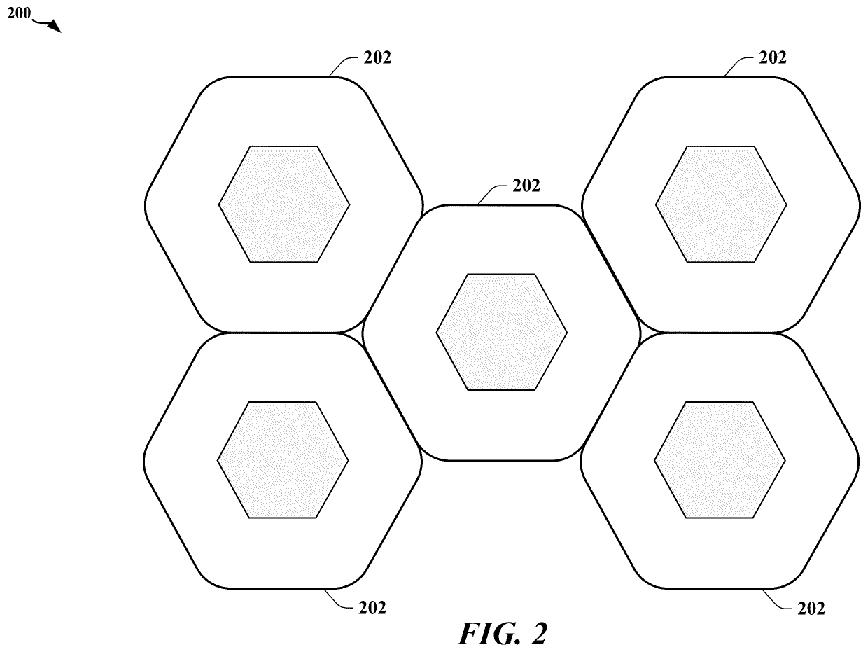

FIG. 2 illustrates an example of an arrangement 200 of charging cells 202 provided on a single layer of a segment or portion of a charging surface that may be adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

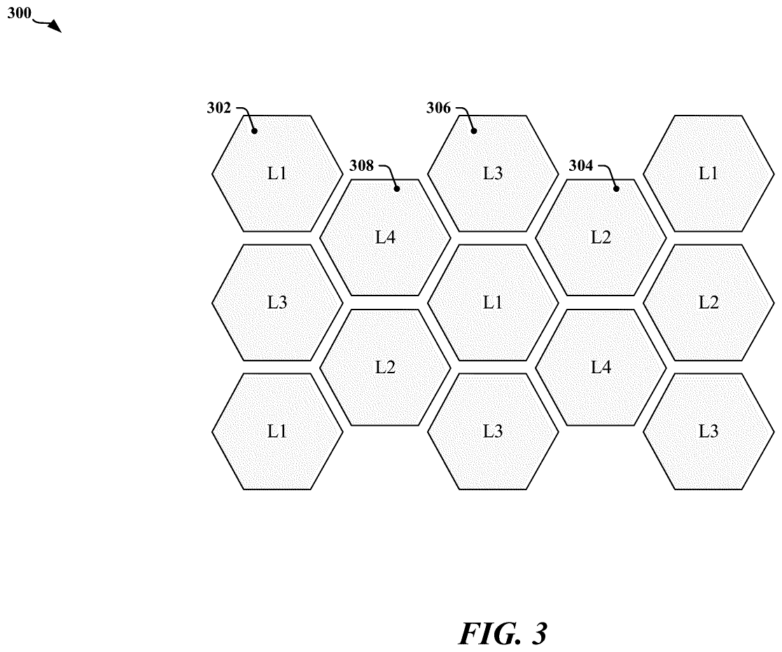

FIG. 3 illustrates the arrangement of power transfer areas provided across a charging surface 300 of a charging device that employs multiple layers of charging cells configured in accordance with certain aspects disclosed herein. The charging device may be constructed from four layers of charging cells 302, 304, 306, 308. In FIG. 3, each power transfer area provided by a charging cell in the first layer of charging cells 302 is marked “L1”, each power transfer area provided by a charging cell in the second layer of charging cells 304 is marked “L2”, each power transfer area provided by a charging cell in the third layer of charging cells 306 is marked “L3”, and each power transfer area provided by a charging cell in the fourth layer of charging cells 308 is marked “L4”.

In accordance with certain aspects disclosed herein, location sensing may rely on changes in some property of the electrical conductors that form coils in a charging cell. Measurable differences in properties of the electrical conductors may include capacitance, resistance, inductance and/or temperature. In some examples, loading of the charging surface can affect the measurable resistance of a coil located near the point of loading. In some implementations, sensors may be provided to enable location sensing through detection of changes in radiated or reflected light, touch, pressure, load and/or strain. Certain aspects disclosed herein provide apparatus and methods that can sense the location of devices that may be freely placed on a charging surface using low-power differential capacitive sense techniques.

According to certain aspects disclosed herein, power transmitting coils in one or more charging cells may be selectively activated to provide an optimal electromagnetic field for charging a compatible device. In some instances, power transmitting coils may be assigned to charging cells, and some charging cells may overlap other charging cells. The optimal charging configuration may be selected at the charging cell level. In some examples, a charging configuration may include charging cells in a charging surface that are determined to be aligned with or located close to the device to be charged. A controller may activate a single power transmitting coil or a combination of power transmitting coils based on the charging configuration which in turn is based on detection of location of the device to be charged. In some implementations, a wireless charging device may have a driver circuit that can selectively activate one or more power transmitting coils or one or more predefined charging cells during a charging event.

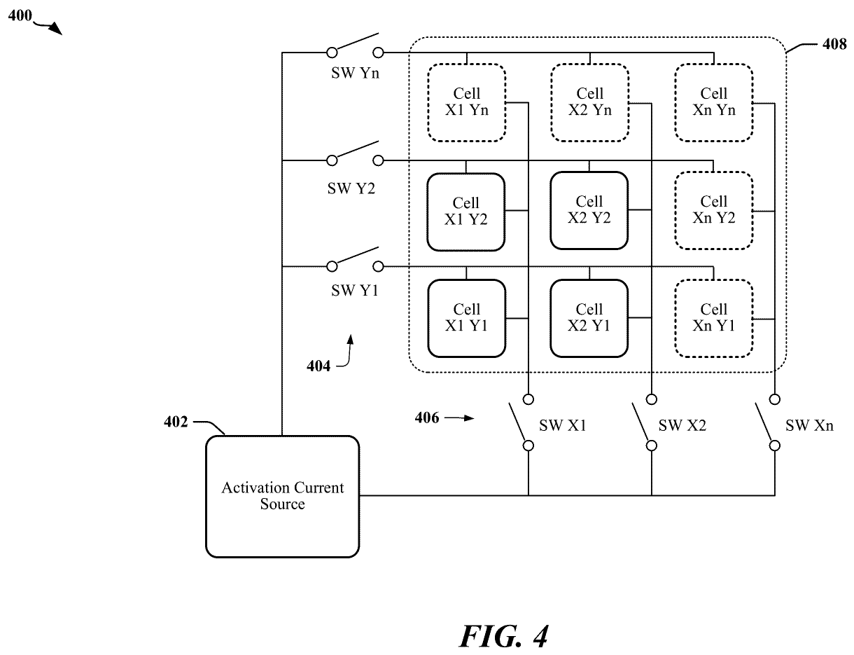

FIG. 4 illustrates a first topology 400 that supports matrix multiplexed switching for use in a wireless charging device adapted in accordance with certain aspects disclosed herein. The wireless charging device may select one or more charging cells 100 to charge a receiving device. Charging cells 100 that are not in use can be disconnected from current flow. A relatively large number of charging cells 100 may be used in the honeycomb packaging configuration illustrated in FIG. 2, requiring a corresponding number of switches. According to certain aspects disclosed herein, the charging cells 100 may be logically arranged in a matrix 408 having multiple cells connected to two or more switches that enable specific cells to be powered. In the illustrated topology 400, a two-dimensional matrix 408 is provided, where the dimensions may be represented by X and Y coordinates. Each of a first set of switches 406 is configured to selectively couple a first terminal of each cell in a column of cells to a first terminal of a voltage or current source 402 that provides current to activate coils in one or more charging cells during wireless charging. Each of a second set of switches 404 is configured to selectively couple a second terminal of each cell in a row of cells to a second terminal of the voltage or current source 402. A charging cell is active when both terminals of the cell are coupled to the voltage or current source 402.

The use of a matrix 408 can significantly reduce the number of switching components needed to operate a network of tuned LC circuits. For example, N individually connected cells require at least N switches, whereas a two-dimensional matrix 408 having N cells can be operated with \sqrt{N} switches. The use of a matrix 408 can produce significant cost savings and reduce circuit and/or layout complexity. In one example, a 9-cell implementation can be implemented in a 3×3 matrix 408 using 6 switches, saving 3 switches. In another example, a 16-cell implementation can be implemented in a 4×4 matrix 408 using 8 switches, saving 8 switches.

During operation, at least 2 switches are closed to actively couple one coil or charging cell to the voltage or current source 402. Multiple switches can be closed at once in order to facilitate connection of multiple coils or charging cells to the voltage or current source 402. Multiple switches may be closed, for example, to enable modes of operation that drive multiple transmitting coils when transferring power to a receiving device.

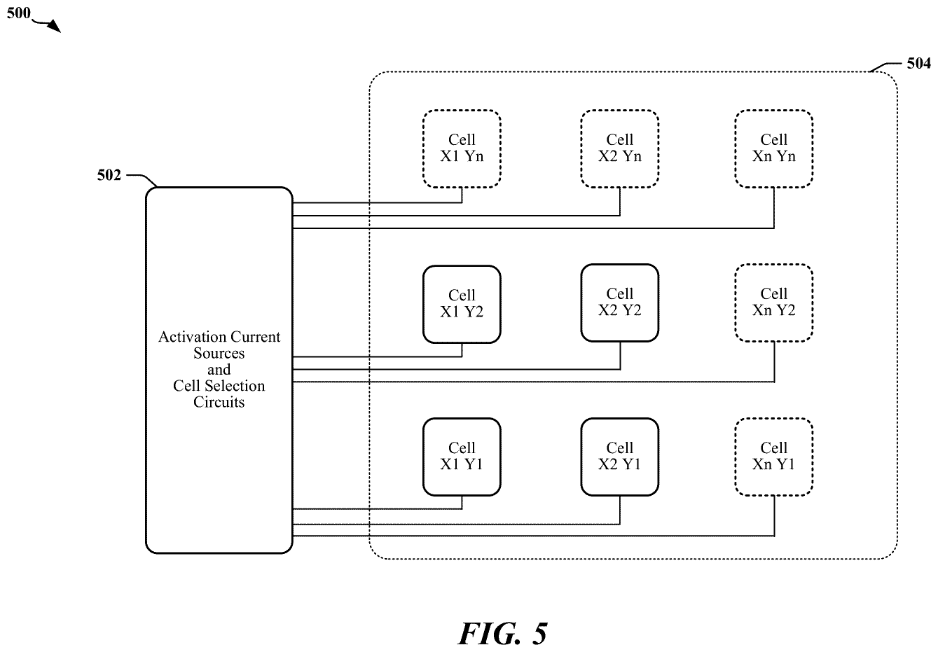

FIG. 5 illustrates a second topology 500 in which each individual coil or charging cell is directly driven by a driver circuit 502 in accordance with certain aspects disclosed herein. The driver circuit 502 may be configured to select one or more coils or charging cells 100 from a group of coils 504 to charge a receiving device. It will be appreciated that the concepts disclosed here in relation to charging cells 100 may be applied to selective activation of individual coils or stacks of coils. Charging cells 100 that are not in use receive no current flow. A relatively large number of charging cells 100 may be in use and a switching matrix may be employed to drive individual coils or groups of coils. In one example, a first switching matrix may configure connections that define a charging cell or group of coils to be used during a charging event and a second switching matrix may be used to activate the charging cell and/or group of selected coils.

According to certain aspects of this disclosure, a charging surface may be provided using wireless charging modules that include one or more charging coils arranged in substantially parallel alignment adjacent or proximate to the charging surface. According to one aspect, a charging system may include charging modules configured to provide a large surface area on which a chargeable device can be placed for charging and which can be controlled, managed or drive by one or more controlling subsystems. In some implementations, the charging modules may be physically coupled, joined or otherwise provided in a side-by-side or end-on-end configuration to provide a combined charging surface with a desired length, breadth or surface area. In some implementations, two or more of the charging modules may be physically separated and may provide multiple charging surfaces within a room or cabin of a vehicle or in different locations of an item of furniture, such as a desk, table, workbench, countertop including bar and kitchen worksurfaces, or the like. The charging system may include charging modules that have the same charging coil configuration, including same size and layout of charging coils. In some examples, the charging system includes different types of charging modules, including charging modules with different layouts, differently sized charging coils and/or different size. In some examples, a charging module may include charging coils of different sizes. In some examples, a charging module may include charging coils of different shapes. In some examples, a charging module may be constructed using a flexible printed circuit board (PCB) while other modular charging modules may be manufactured using inflexible materials.

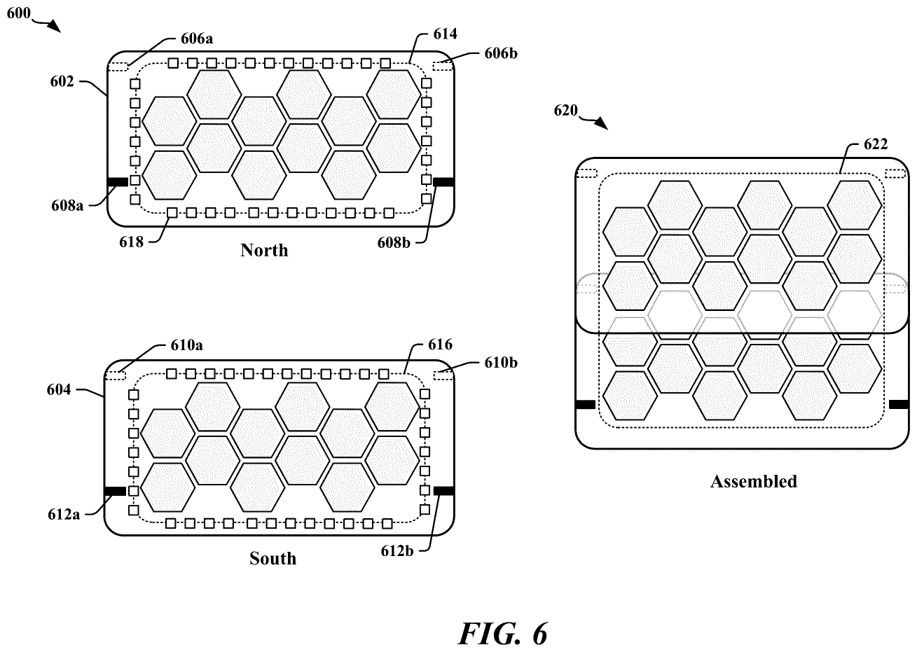

FIG. 6 illustrates an example in which a modular charging surface can be formed in accordance with certain aspects disclosed herein. The modular charging surface is constructed from two interconnected charging modules 602, 604. As illustrated in the pre-assembly view 600, the charging modules 602, 604 have a common size and shape, and a group of transmitting coils disposed across a charging surface provided by each charging module 602, 604. In this example, the charging modules 602, 604 are configured to be overlaid in either direction. In the illustrated example, the charging modules 602, 604 are configured to be overlaid in a North-South direction. Other configurations of the charging modules 602, 604 are contemplated. The charging modules 602, 604 may be overlaid to create a charging surface that is an integer N times the width of the area of a charging module 602, 604 that is delimited by an indicator line 614, 616. The illustrated assembled view 620 provides an example in which N=2, and where a North-side charging module 602 overlays a South-side charging module 604.

In certain implementations, light sources such as light emitting diode (LED) lamps or strips of LED lamps are provided to illuminate the indicator lines 614, 616 through a countertop, tabletop or other worktop. In certain implementations, the light sources may be electrically coupled to the charging module 602, as illustrated in the example by the LED lamp 618. In certain implementations, the light sources may be electrically coupled to the charging module 602, while being physically movable and/or manipulable without affecting the position of the charging module 602.

In some implementations, the indicator lines 614, 616 are defined by packaging specifications or designs and may not be physically inscribed, printed or otherwise marked on the surface of a countertop, tabletop or other worktop. In these implementations, the indicator lines 614, 616 are visible only when illuminating light is provided by at least one light source. In some implementations, the indicator lines 614, 616 may be physically marked on the countertop, tabletop or other worktop using silkscreen printing or other appropriate means, such that the indicator lines 614, 616 are visible even when the light sources are disabled. In one example, the light sources or associated light conducting materials may be visible even when no light is produced by the light sources. The indicator line 614, 616 may circumscribe the outline or outer limits of the transmitting coils.

In some implementations, light from the light sources may pass through the body of the countertop, tabletop or other worktop to illuminate the indicator lines 614, 616. In some implementations, the thickness of the countertop, tabletop or other worktop may be reduced proximate to the indicator lines 614, 616 in order to permit light from the light sources to propagate through the body of the countertop, tabletop or other worktop to illuminate the indicator lines 614, 616.

In some examples, light from the LED lamps is carried to an upper surface of the table, desk, workbench, bar top, kitchen worksurface, or other surface through light pipes, light guides and/or light diffusing materials or devices. A light pipe, for example, may be implemented LED light pipe using one or more optical fibers, a rod or shaft formed from a transparent polymer and the light pipe may be used to conduct light from an LED mounted on the charging module 602 to the upper surface of a countertop, desktop table, etc. In some implementations, light pipes, light guides or light diffusers may be used alone or in combination to provide a visible indicator line on the table, desk, workbench, bar top, kitchen worksurface, or other surface. In these latter implementations, the visible indicator line may be illuminated when a chargeable device is detected nearby. In some implementations, the charging module 602 or a controller may be configured with information that determines when the indicator line is illuminated. For example, the information may cause the indicator line to be illuminated permanently, for a defined duration, or for a period of time after occurrence of an event such as the detection of a chargeable device, presence of a user, or receipt of a command or other communication from a home automation system or from another controller. The information may cause the visible indicator line to be illuminated with a first color to indicate availability of charging circuits and with a second color to indicate that the charging surface is in use. In some instances, the color of the visible indicator line may indicate whether charging is in progress or completed, or whether an error has occurred. The error may relate to misalignment of the chargeable device, presence of a foreign object, an overheating condition or the like.

Light sources, including LED lamps, may be configured to emit light that is visible to a user before placement of a device on a charging surface, after placement of the device on the charging surface and/or while charging the device through the charging surface. In some instances, the light sources may be activated when presence of a person is detected in the vicinity of the table, desk, workbench, bar top, kitchen worksurface, or other surface that includes the charging surface. For example, a change in lighting, a communication from a home automation device or controller, detection of sound or receipt of a voice command may cause the light sources to be activated. In some implementations, the frequency or rate at which the wireless charging module searches for chargeable devices may be increased when the light sources are activated. In some implementations, the frequency at which the wireless charging module searches for chargeable devices may be increased when a person is detected in the vicinity of the table, desk, workbench, bar top, kitchen worksurface, or other surface that includes the charging surface.

In various examples and configurations described in this disclosure, a charging surface may be provided as a portion of the surface of a desk, table, workbench, countertop including bar and kitchen worksurfaces, or other item of furniture through which electromagnetic flux can be delivered by one or more power transmitting coils in a wireless charging module. Typically, the wireless charging module is located below the surface of the desk, table, workbench, countertop, bar worksurface, kitchen worksurface, or an item of furniture.

The transmitting coils of the charging modules 602, 604 may be arranged in a pattern that continues uninterrupted when the charging modules 602, 604 are overlaid. A combined indicator line 622 may be defined by the location of LED lamps, portions of strips of LED lamps or other light sources that are available for use during operation of the charging module. A processing circuit may manage operation of the LEDs or strips of LEDs. In one example, a controller of the processing circuit may detect the presence or absence of a chargeable device and may select some combination of LED lamps to be illuminated in order to provide a visual reference that assists a user to properly locate the charging surface. The controller may also configure colors for the LEDs to indicate state and progress of a charging transaction, error conditions and the like. In one example, the controller may configure a first color for the LEDs to indicate a charging area that is available for charging, a second color for the LEDs to indicate the charging area is being used for charging, and a third color for the LEDs to indicate that charging has been completed. In one example, the controller may configure a first sequence of color changes for the LEDs to indicate a charging area that is available for charging, a second sequence of color changes for the LEDs to indicate the charging area is being used for charging, and a third sequence of color changes for the LEDs to indicate that charging has been completed. Each sequence of color changes may the LEDs to emit a pattern of light. The controller may configure the intensity of light emitted by the LEDs to accommodate changes in ambient lighting.

In the illustrated example, each charging module 602, 604 has underside connector areas 606a, 606b, 610a, 610b and topside connector areas 608a, 608b, 612a, 612b that are positioned to overlap when the charging modules 602, 604 are overlaid. Mechanical fasteners may be located in the underside connector areas 606a, 606b, 610a, 610b and topside connector areas 608a, 608b, 612a, 612b. Mechanical fasteners may include bonding points, screws, or other devices that can fasten and/or hold the charging modules 602, 604 in place when overlaid. Electrical connectors may be located in the underside connector areas 606a, 606b, 610a, 610b and topside connector areas 608a, 608b, 612a, 612b. The electrical connectors may conduct data communication links and/or charging currents between the charging modules 602, 604 enabling a controller to configure and operate groups of transmitting coils when charging a receiving device placed on or near the charging surface.

According to certain aspects of this disclosure, a charging module provided in wireless charging system may be implemented using charging cells that include at least one Litz coil. A Litz coil may be constructed using a Litz wire to form a planar or substantially flat winding. The Litz coil may be configured with a central power transfer area that produces an electromagnetic flux when a charging current is passed through the Litz wire. Each charging cell may include or be associated with multiple Litz coils arranged to have coaxial or overlapping power transfer areas. In some instances, the charging cells may be arranged parallel to and adjacent to the charging surface of the charging module without overlap of the charging cells. In some instances, the charging cells may be arranged in multiple parallel layers, extending from a first layer that is parallel with and adjacent to the charging surface of the charging module. In some instances, Litz coils in each layer may at least partially overlap Litz coils in other layers.

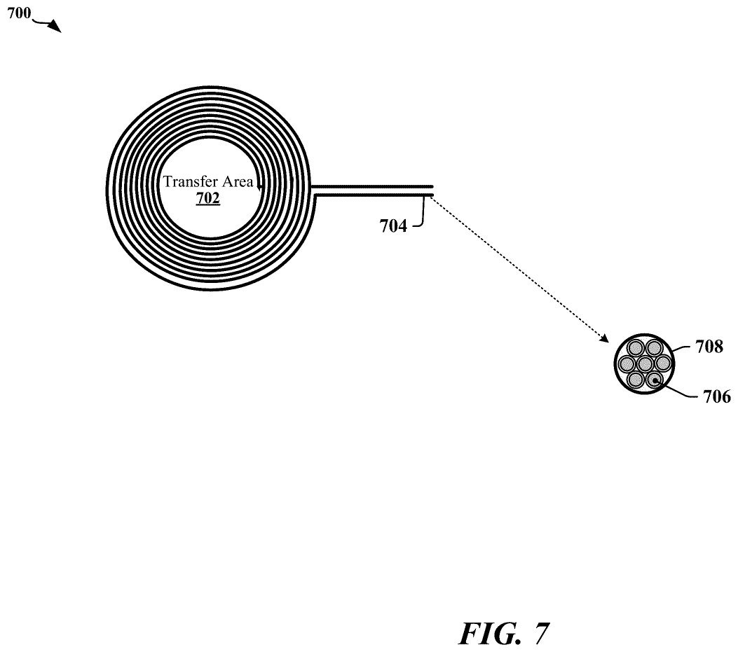

FIG. 7 illustrates an example of a transmitting coil configured in accordance with certain aspects of this disclosure. The transmitting coil may be wound from a multi-stranded Litz wire 704 and may be referred to as a Litz coil 700. Each strand 706 of the Litz wire 704 is formed as an insulated conductor that is sufficiently thin to mitigate or substantially reduce skin effect loss. Skin effect losses can occur in wires carrying high frequency signals. Current tends to flow at the outermost reaches (skin) of the wire, and the increased current density can increase localized heating and electrical resistance. The strands 706 of the Litz wire 704 are insulated to maintain their individual nature and are twisted such that the relative positioning of the individual strands 706 changes over the length of the Litz wire 704. In some instances, the strands 706 are bound by an exterior insulating layer 708. The Litz coil 700 can be wound as a substantially planar coil with an open interior that corresponds to a power transfer area 702.

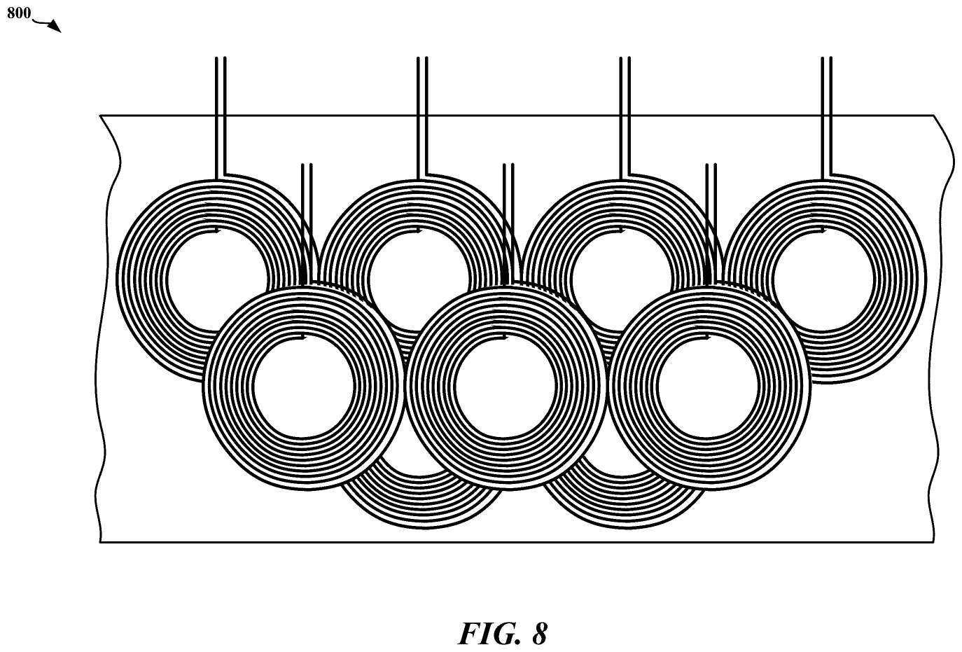

FIG. 8 illustrates an example of a portion of a charging surface 800 provided using multiple overlapping Litz coils 700. In the illustrated example, the charging surface 800 is constructed using three layers of Litz coils 700, although the number of layers of Litz coils 700 and arrangement of the Litz coils 700 in the charging surface 800 may vary according to application, size of the charging surface 800 and power transfer requirements per Litz coil 700.

The configuration of Litz coils 700 in a charging surface 800 may be precisely defined by design requirements. In some instances, it can be difficult to manage and align the number of Litz coils 700 to be assembled during manufacture of a wireless charging module that provides a free-positioning charging surface using multiple transmitting coils. Variability in positioning of the Litz coils 700 during manufacture can result in imprecise configurations of coils in some finished devices. In some instances, the Litz coils 700 may be retained in position using an adhesive or epoxy resin. According to certain aspects of this disclosure, a substrate may be configured to receive the Litz coils 700 and maintain the Litz coils 700 in a desired configuration for the lifetime of the wireless charging module.

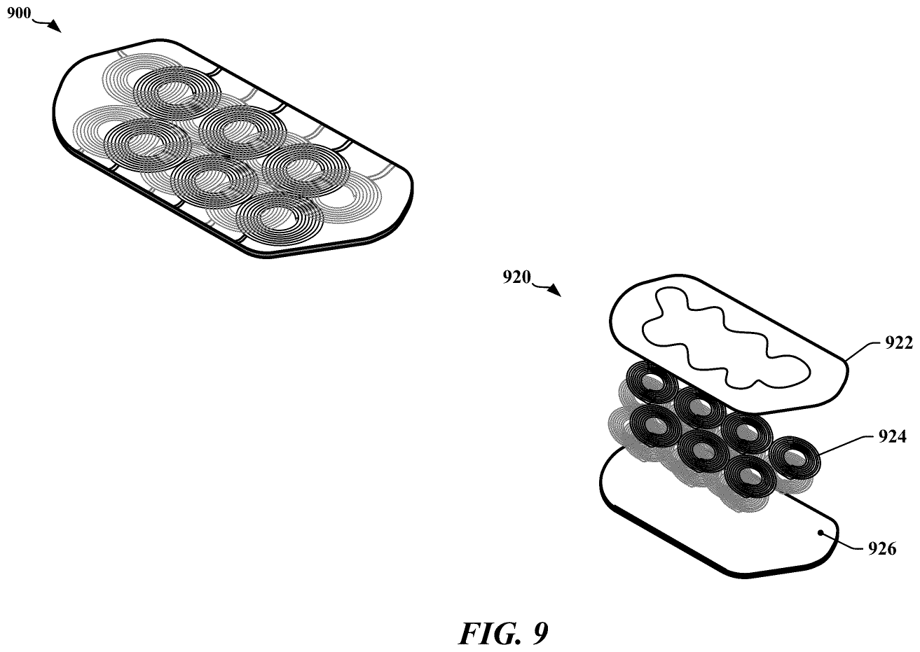

FIG. 9 illustrates a charging module 900 in a wireless charging module constructed from Litz coils 700 according to certain aspects of this disclosure. The exploded view 920 shows a Litz coil substrate 922 configured to receive Litz coils and maintain the Litz coils in a predefined multi-layer Litz coil structure 924 with 3D displacements between coils that meet tolerances defined by a designer. The Litz coil substrate 922 may also define the spatial relationship between the multi-layer Litz coil structure 924 and a ferrite layer 926 or another type of magnetic half-core.

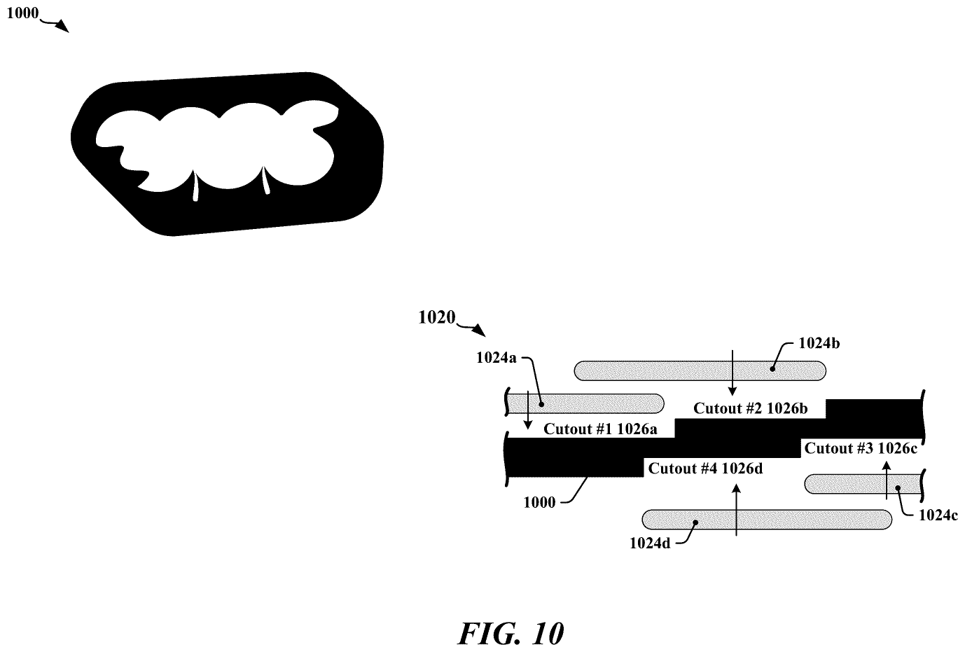

FIG. 10 illustrates certain aspects of a Litz coil substrate 1000 provided in accordance with certain aspects of this disclosure. The Litz coil substrate 1000 may be formed from a polymer, acetate, vinyl, nitrile rubber, latex, extruded polystyrene foam and/or other material. The Litz coil substrate 1000 may have multiple cutouts that enable Litz coils 700 to be placed in position in an ordered assembly. In some examples, the cut-outs may be preformed, including when the Litz coil substrate 1000 is manufactured by 3D printing, molding, extrusion and/or low-pressure expansion. In some examples, the cut-outs may be formed by milling, grinding, etching, abrading, chemical erosion, chemical dissolution or by another technique suitable for use with the material used to form the Litz coil substrate 1000.

Certain aspects of the Litz coil substrate 1000 are illustrated in a cross-sectional view 1020. The illustrated Litz coil substrate 1000 provides a four-layer charging surface and the cross-sectional view 1020 illustrates an example of placement and assembly of four Litz coils 1024a-1024d. The Litz coil substrate 1000 has a deep, first cutout 1026a in the Litz coil substrate 1000 that receives a first Litz coil 1024a. This first cutout 1026a may be formed as a complete circle in some examples. In other examples, the first cutout 1026a may have a portion that overlaps a portion of another cutout in the same plane of the Litz coil substrate 1000.

When the first Litz coil 1024a has been secured within the first cutout 1026a, a second Litz coil 1024b may be placed in a second cutout 1026b in the Litz coil substrate 1000. When in position within the Litz coil substrate 1000, the second Litz coil 1024b lies in a plane above the plane that includes the first Litz coil 1024a. A portion of the second Litz coil 1024b overlaps a portion of the first Litz coil 1024a. The separation of the planes that include the horizontal center lines of the first Litz coil 1024a and the second Litz coil 1024b may be configured by the relative difference in depths of the first cutout 1026a and the second cutout 1026b.

The third Litz coil 1024c is received by a deep, third cutout 1026c in the Litz coil substrate 1000. This third cutout 1026c may be formed as a complete circle in some examples. In other examples, the third cutout 1026c may overlap with another cutout in the same plane. In one example, the third cutout 1026c may partially overlap the first cutout 1026a resulting in a through-hole, when the bottom surface of the first Litz coil 1024a is in the same plane as the top surface or some other portion of the third Litz coil 1024c.

When the third Litz coil 1024c has been secured within the third cutout 1026c, a fourth Litz coil 1024d may be placed in a fourth cutout 1026d. The fourth Litz coil 1024d lies in a plane below the plane that includes the third Litz coil 1024c. A portion of the fourth Litz coil 1024d overlaps a portion of the third Litz coil 1024c when secured within the Litz coil substrate 1000. The separation of the planes that include the horizontal center lines of the third Litz coil 1024c and the fourth Litz coil 1024d may be configured by the relative difference in depths of the third cutout 1026c and the fourth cutout 1026d.

A Litz coil 1024a-1024d may be secured within the Litz coil substrate 1000 through a pressure fit, including when the Litz coil substrate 1000 is manufactured from a foam material. In some examples, a Litz coil 1024a-1024d may be secured within the Litz coil substrate 1000 by adhesive. In some examples, a Litz coil 1024a-1024d may be secured within the Litz coil substrate 1000 by mechanical means.

In some implementations, a completed charging assembly comprising the Litz coil substrate 1000 and the Litz coils 1024a-1024d may be attached to, or mounted on a substrate, which may be retained within a housing that can be mounted under a countertop, for example. In some implementations, the completed charging assembly comprising the Litz coil substrate 1000 and the Litz coils 1024a-1024d may be attached to, or mounted on a printed circuit board, which may be retained within a housing.

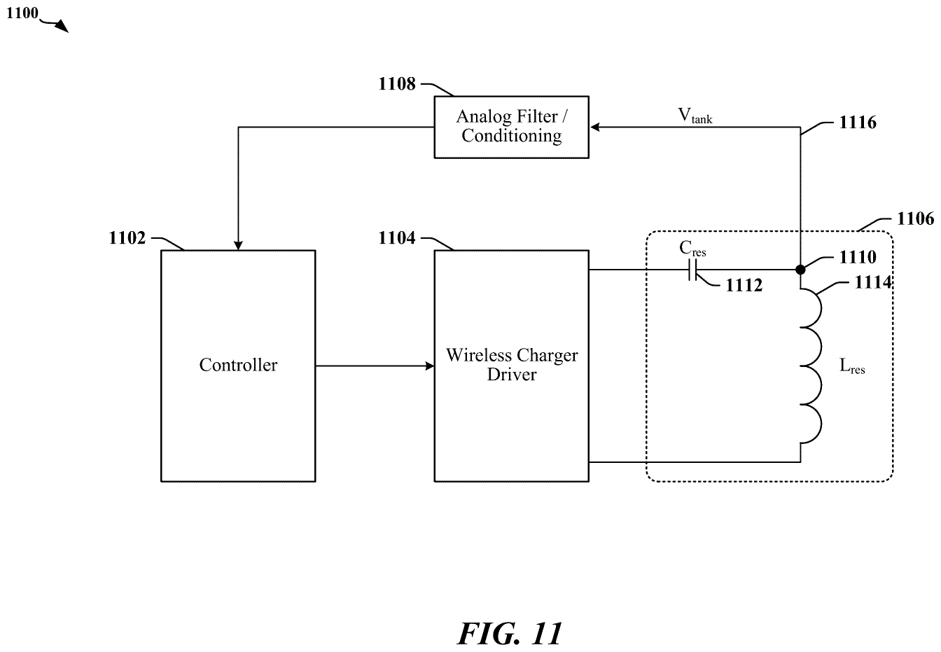

FIG. 11 illustrates an example of a wireless power transmitter 1100 that can be provided in a base station of a wireless charging device. A base station in a wireless charging device may include one or more processing circuits used to control operations of the wireless charging device. A controller 1102 may receive a feedback signal filtered or otherwise processed by a filter circuit 1108. The controller may control the operation of a driver circuit 1104 that provides an alternating current to a resonant circuit 1106. In some examples, the controller 1102 may generate a digital frequency reference signal used to control the frequency of the alternating current output by the driver circuit 1104. In some instances, the digital frequency reference signal may be generated using a programmable counter or the like. In some examples, the driver circuit 1104 includes a power inverter circuit and one or more power amplifiers that cooperate to generate the alternating current from a direct current source or input. In some examples, the digital frequency reference signal may be generated by the driver circuit 1104 or by another circuit. The resonant circuit 1106 includes a capacitor 1112 and inductor 1114. The inductor 1114 may represent or include one or more transmitting coils in a charging cell that produced a magnetic flux responsive to the alternating current. The resonant circuit 1106 may also be referred to herein as a tank circuit, LC tank circuit, or LC tank, and the voltage 1116 measured at an LC node 1110 of the resonant circuit 1106 may be referred to as the tank voltage.

Passive ping techniques may use the voltage and/or current measured or observed at the LC node 1110 to identify the presence of a receiving coil in proximity to the charging pad of a device adapted in accordance with certain aspects disclosed herein. Some conventional wireless charging devices include circuits that measure voltage at the LC node 1110 of the resonant circuit 1106 or the current in the resonant circuit 1106. These voltages and currents may be monitored for power regulation purposes and/or to support communication between devices. According to certain aspects of this disclosure, voltage at the LC node 1110 in the wireless power transmitter 1100 illustrated in FIG. 11 may be monitored to support passive ping techniques that can detect presence of a chargeable device or other object based on response of the resonant circuit 1106 to a short burst of energy (the ping) transmitted through the resonant circuit 1106.

A passive ping discovery technique may be used to provide fast, low-power discovery. A passive ping may be produced by driving a network that includes the resonant circuit 1106 with a fast pulse that includes a small amount of energy. The fast pulse excites the resonant circuit 1106 and causes the network to oscillate at its natural resonant frequency until the injected energy decays and is dissipated. The response of a resonant circuit 1106 to a fast pulse may be determined in part by the resonant frequency of the resonant LC circuit. A response of the resonant circuit 1106 to a passive ping that has initial voltage=V₀ may be represented by the voltage V_{LC} observed at the LC node 1110, such that:

$${V}_{L C} = {V}_{0} {e}^{- ( \frac{ω}{2 Q} ) t} \qquad ( Eq . l )$$

The resonant circuit 1106 may be monitored when the controller 1102 or another processor is using digital pings to detect presence of objects. A digital ping is produced by driving the resonant circuit 1106 for a period of time. The resonant circuit 1106 is a tuned network that includes a transmitting coil of the wireless charging device. A receiving device may modulate the voltage or current observed in the resonant circuit 1106 by modifying the impedance presented by its power receiving circuit in accordance with signaling state of a modulating signal. The controller 1102 or other processor then waits for a data modulated response that indicates that a receiving device is nearby.

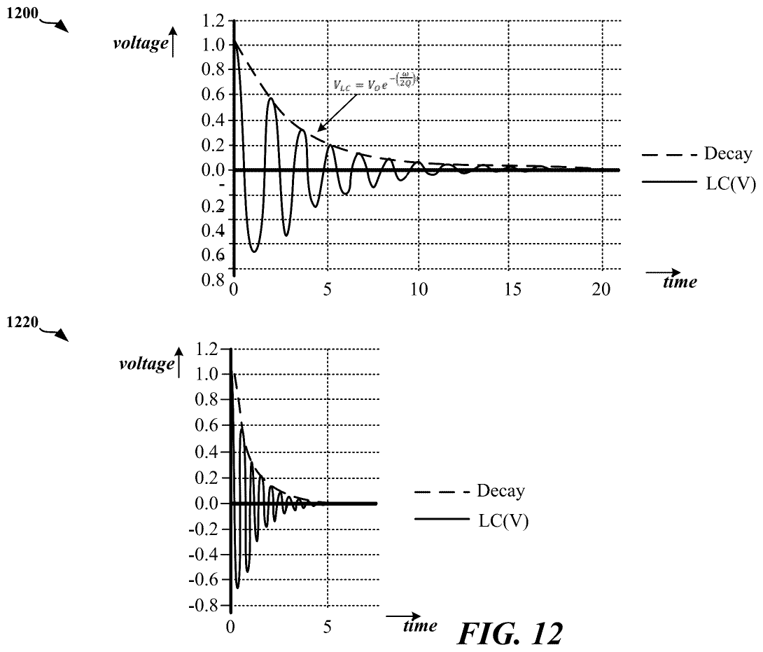

FIG. 12 illustrates examples of responses 1200, 1220 to a passive ping. In each of the responses 1200, 1220, an initial voltage decays according to Equation 3. After the excitation pulse at time=0, the voltage and/or current is seen to oscillate at the resonant frequency defined by Equation 1, and with a decay rate defined by Equation 3. The first cycle of oscillation begins at voltage level V₀ and V_{LC} continues to decay to zero as controlled by the Q factor and co. The first response 1200 illustrates a typical open or unloaded response when no object is present or proximate to the charging pad. In this first response 1200, the value of the Q factor may be assumed to be 20. The second response 1220 illustrates a loaded response that may be observed when an object is present or proximate to the charging pad loads the coil. In the illustrated second response 1220, the Q factor may have a value of 7. V_{LC} oscillates at a higher frequency in the voltage response 1220 with respect to the voltage response 1200.

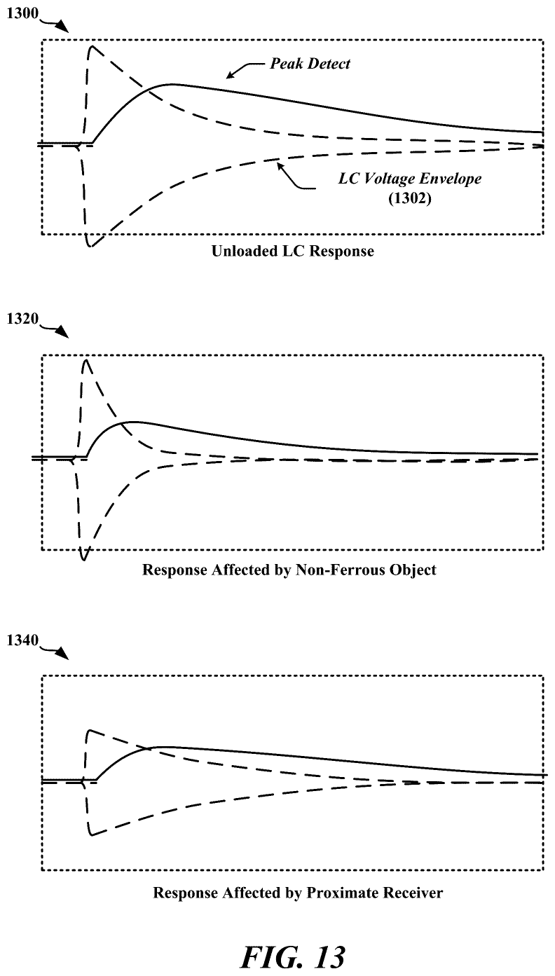

FIG. 13 illustrates a set of examples in which differences in responses 1300, 1320, 1340 may be observed. A passive ping is initiated when a driver circuit 1104 excites the resonant circuit 1106 using a pulse that is shorter than 2.5 μs. Different types of wireless receivers and foreign objects placed on the transmitter result in different responses observable in the voltage at the LC node 1110 or current in the resonant circuit 1106 of the transmitter. The differences may indicate variations in the Q factor of the resonant circuit 1106 frequency of the oscillation of V₀. Table 2 illustrates certain examples of objects placed on the charging pad in relation to an open state.

TABLE 2

| Object | Frequency | | Vₚₑₐₖ (mV) | | 50% Decay Cycles | Q Factor |
|---|---|---|---|---|---|---|
| None present | 96.98 | kHz | 134 | mV | 4.5 | 20.385 |
| Type-1 Receiver | 64.39 | kHz | 82 | mV | 3.5 | 15.855 |
| Type-2 Receiver | 78.14 | kHz | 78 | mV | 3.5 | 15.855 |
| Type-3 Receiver | 76.38 | kHz | 122 | mV | 3.2 | 14.496 |
| Misaligned Type-3 Receiver | 210.40 | kHz | 110 | mV | 2.0 | 9.060 |
| Ferrous object | 93.80 | kHz | 110 | mV | 2.0 | 9.060 |
| Non-ferrous object | 100.30 | kHz | 102 | mV | 1.5 | 6.795 |

The Q factor listed in In Table 2 may be calculated as follows:

$$Q = \frac{π N}{ln ( 2 )} ≅ 4.53 N , \qquad ( Eq . 4 )$$

where N is the number of cycles from excitation until amplitude falls below 0.5 V₀.

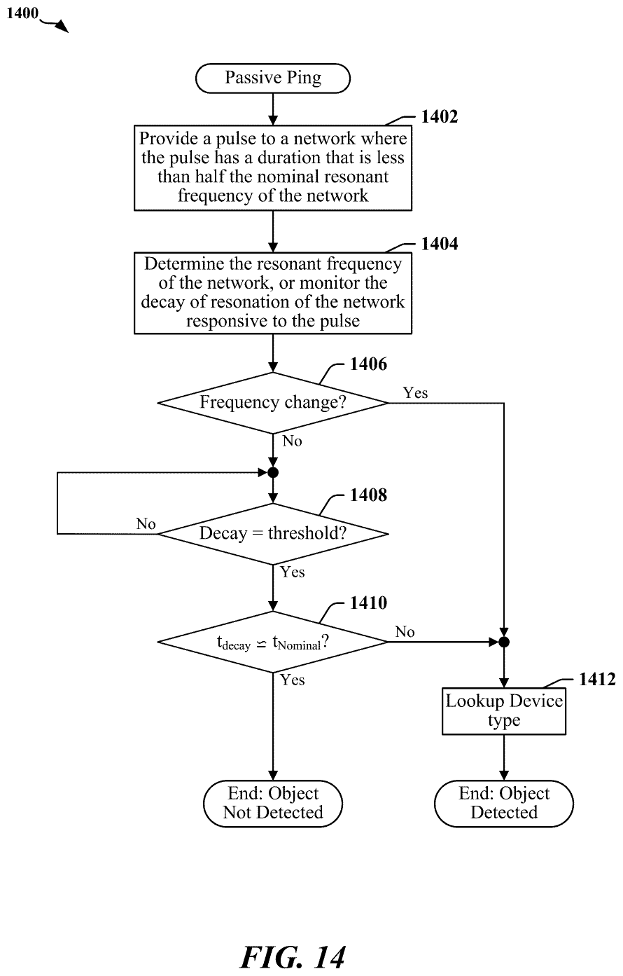

FIG. 14 is a flowchart 1400 that illustrates a method involving passive ping implemented in a wireless charging device adapted in accordance with certain aspects disclosed herein. At block 1402, a controller may generate a short excitation pulse and may provide the short excitation pulse to a network that includes a resonant circuit. The network may have a nominal resonant frequency and the short excitation pulse may have a duration that is less than half the nominal resonant frequency of the network. The nominal resonant frequency may be observed when the transmitting coil of the resonant circuit is isolated from external objects, including ferrous objects, non-ferrous objects and/or receiving coils in a device to be charged.

At block 1404, the controller may determine the resonant frequency of the network or may monitor the decay of resonation of the network responsive to the pulse. According to certain aspects disclosed herein, the resonant frequency and/or the Q factor associated with the network may be altered when a device or other object is placed in proximity to the transmitting coil. The resonant frequency may be increased or decreased from the nominal resonant frequency observed when the transmitting coil of the resonant circuit is isolated from external objects. The Q factor of the network may be increased or decreased with respect to a nominal Q factor measurable when the transmitting coil of the resonant circuit is isolated from external objects. According to certain aspects disclosed herein, the duration of delay can be indicative of the presence or type of an object placed in proximity to the transmitting coil when differences in Q factor prolong or accelerate decay of amplitude of oscillation in the resonant circuit with respect to delays associated with a nominal Q factor.

In one example, the controller may determine the resonant frequency of the network using a transition detector circuit configured to detect zero crossings of a signal representative of the voltage at the LC node 1110 using a comparator or the like. In some instances, direct current (DC) components may be filtered from the signal to provide a zero crossing. In some instances, the comparator may account for a DC component using an offset to detect crossings of a common voltage level. A counter may be employed to count the detected zero crossings. In another example the controller may determine the resonant frequency of the network using a transition detector circuit configured to detect crossings through a threshold voltage by a signal representative of the voltage at the LC node 1110, where the amplitude of the signal is clamped or limited within a range of voltages that can be detected and monitored by logic circuits. In this example, a counter may be employed to count transitions in the signal. The resonant frequency of the network may be measured, estimated and/or calculated using other methodologies.

In another example, a timer or counter may be employed to determine the time taken for V_{LC} to decay from voltage level V₀ to a threshold voltage level. The elapsed time may be used to represent a decay characteristic of the network. The threshold voltage level may be selected to provide sufficient granularity to enable a counter or timer to distinguish between various responses 1300, 1320, 1340 to the pulse. V_{LC} may be represented by detected or measured peak, peak-to-peak, envelope 1302 and/or rectified voltage level. The decay characteristic of the network may be measured, estimated and/or calculated using other methodologies.

If at block 1406, the controller determines that a change in resonant frequency with respect to a nominal resonant frequency indicate presence of an object in proximity to the transmitting coil, the controller may attempt to identify the object at block 1412. If the controller determines at block 1406 that resonant frequency is substantially the same as the nominal resonant frequency, the controller may consider the decay characteristic of the amplitude of oscillation in the resonant circuit at block 1408. The controller may determine that the resonant frequency of the network is substantially the same as the nominal resonant frequency when the frequency remains within a defined frequency range centered on, or including the nominal resonant frequency. In some implementations, the controller may identify objects using changes in resonant frequency and decay characteristics. In these latter implementations, the controller may continue at block 1408 regardless of resonant frequency, and may use changes in change in resonant frequency as an additional parameter when identifying an object positioned proximately the transmission coil.

At block 1408, the controller may use a timer and/or may count the cycles of the oscillation in the resonant circuit that have elapsed between the initial V₀ amplitude and a threshold amplitude used to assess the decay characteristic. In one example, V₀/2 may be selected as the threshold amplitude. At block 1410, the number of cycles or the elapsed time between the initial V₀ amplitude and the threshold amplitude may be used to characterize decay in the amplitude of oscillation in the resonant circuit, and to compare the characterize decay with a corresponding nominal decay characteristic. If at block 1410, no change in frequency and delay characteristic is detected, the controller may terminate the procedure with a determination that no object is proximately located to the transmission coil. If at block 1410, a change in frequency and/or delay characteristic has been detected, the controller may identify the object at block 1412.

At block 1412, the controller may be configured to identify receiving devices placed on a charging pad. The controller may be configured to ignore other types of objects, or receiving devices that are not optimally placed on the charging pad including, for example, receiving devices that are misaligned with the transmission coil that provides the passive ping. In some implementations, the controller may use a lookup table indexed by resonant frequency, decay time, change in resonant frequency, change in decay time and/or Q factor estimates. The lookup table may provide information identifying specific device types, and/or charging parameters to be used when charging the identified device or type of device.

Passive ping uses a very short excitation pulse that can be less than a half-cycle of the nominal resonant frequency observed at the LC node 1110 in the resonant circuit 1106. A conventional ping may actively drive a transmission coil for more than 16,000 cycles. The power and time consumed by a conventional ping can exceed the power and time use of a passive ping by several orders of magnitude. In one example, a passive ping consumes approximately 0.25 μJ per ping with a max ping time of around ˜100 μs, while a conventional active ping consumes approximately 80 mJ per ping with a max ping time of around 90 ms. In this example, energy dissipation may be reduced by a factor of 320,000 and the time per ping may be reduced by a factor of 1100.

Detection and characterization of the decay of the voltage at the LC node 1110 may require fast, sensitive and/or low-voltage circuits to accommodate the low-power nature of resonant signals at the LC node 1110 when a short excitation pulse is used to produce resonant signals in the resonant circuit 1106. In some instances, passive ping may be implemented using a burst of energy at the nominal resonant frequency of the resonant circuit 1106. The burst of energy may have a duration of several periods of the nominal resonant frequency. This burst-mode passive ping necessarily consumes more energy per ping that passive ping that is initiated by short excitation pulses. The additional energy provides additional time to characterize resonant response.

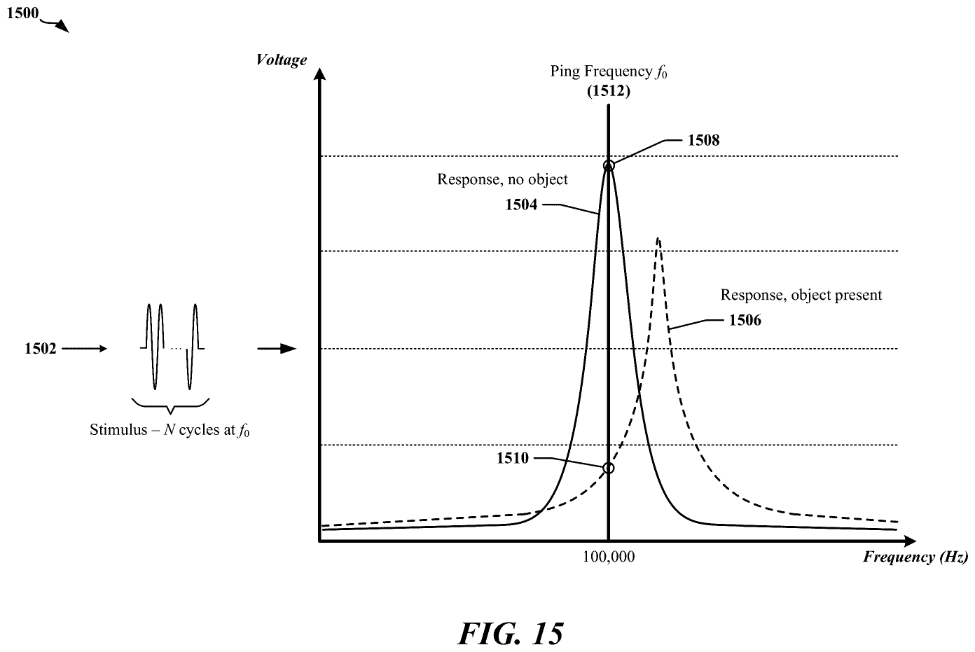

FIG. 15 illustrates an example of frequency response 1500 of the resonant circuit 1106 when the resonant circuit 1106 is stimulated by a ping (here, a passive ping 1502) that includes several cycles of a signal that oscillates at or near the nominal resonant frequency (f₀ 1512) of the resonant circuit 1106. A first frequency response 1504 illustrates the response of the resonant circuit 1106 when no device is present, while a second frequency response 1506 illustrates the response of the resonant circuit 1106 when a chargeable object is present. The chargeable object reduces the Q-factor of the resonant circuit 1106. The higher Q-factor of the resonant circuit 1106 when no device is present causes the resonant circuit 1106 to produce a significantly higher voltage response 1508 and draw the maximum current with the longest decay time in response to a passive ping 1502 at f₀ 1512 than the voltage response 1510 produced when a chargeable device lowers the Q-factor of the resonant circuit 1106, causing the resonant circuit 1106 to produce lower voltage, draw less current and have a shorter decay time in response to a passive ping at f₀ 1512. In typical applications, no object is present for a majority of the time a charging device is in operation, and the resonant circuit 1106 in the charging device has a high Q-factor for a majority of the time. The high Q-factor results in a high power draw. The resonant circuit 1106 has a slower response time when it has a high Q-factor, since more time is needed for the energy in the passive ping 1502 to decay thereby delaying initiation of another ping.

An improved passive ping technique implemented in accordance with certain aspects disclosed herein can reduce power consumption associated with passive pings 1502 and can increase the ping rate. The improved passive ping technique may use a frequency that is significantly different from the resonant frequency of the resonant circuit 1106.

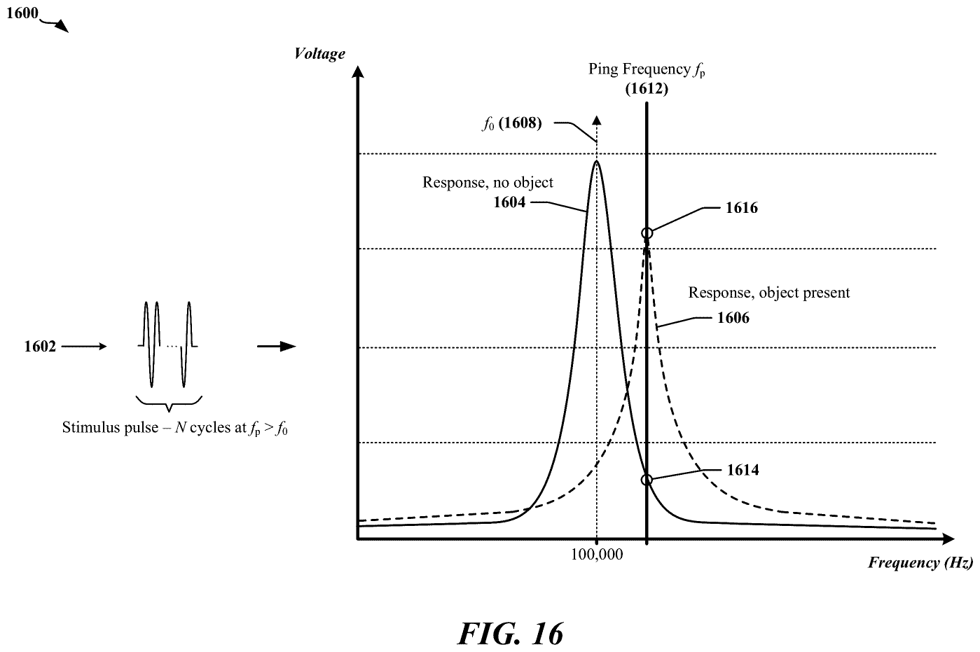

FIG. 16 illustrates an example of frequency responses 1600 of the resonant circuit 1106 illustrating the effect of a ping (here, a pulse 1602) provided as burst of a stimulation signal that oscillates at a frequency (fₚ 1612) that is greater than the nominal resonant frequency (f₀ 1608) of the resonant circuit 1106. The burst spans two or more cycles of the stimulation signal. In one example, the duration of the burst may be controlled by a timer. In another example, the stimulation may be modulated using a gating signal that causes the stimulation signal to be provided to the resonant circuit at a desired repetition rate and with an active duration that defines the number of cycles of the stimulation signal in the burst. In some implementations, the ping is provided as a multi-cycle burst of a stimulation signal that has a frequency that is lower than f₀ 1608.

The use of a stimulation signal that has a frequency different from the resonant frequency of the resonant circuit 1106 can result in the dominant state of the charging device, where no chargeable object is present, to have a lower power draw and faster decay rate than would be expected for a stimulation signal that has a frequency at or near the resonant frequency of the resonant circuit 1106. The use of a non-resonant stimulation signal can provide improved performance with respect to the example illustrated in FIG. 15. The disclosed ping technique can result in increased decay rates and can limit the occurrence of higher-power draws to pulses 1602 that lead to detection of a chargeable object. Additional pulses 1602 are typically superfluous after detection.

The resonant circuit 1106 may be stimulated during a passive ping procedure by a pulsed signal that includes pulses of a duration that can include several cycles at fₚ 1612. A first frequency response 1604 illustrates the response of the resonant circuit 1106 to a pulse 1602 when no device is present, while a second frequency response 1606 illustrates the response of the resonant circuit 1106 to a pulse 1602 when a chargeable object is present. The effect of the chargeable object on the resonant circuit 1106 may be exhibited in a reduction in the Q-factor of the resonant circuit 1106. The resonant circuit 1106 produces a significantly lower voltage level 1614 and draws a lower current with a shorter decay time in response to a ping at fₚ 1612 when no device is present than the voltage level 1616 produced when a chargeable device is present. In typical applications, no object is present for a majority of the time a charging device is in operation, and the resonant circuit 1106 exhibits a lower power consumption and a faster decay time per ping with respect to the example illustrated in FIG. 15.

The frequency spread (fₚ−f₀ or f₀−fₚ) between the resonant frequency (f₀ 1608) and the ping frequency (fₚ 1612) may be proportionate to the value of f₀ 1608. For example, the frequency spread may increase as f₀ 1608 increases. In some implementations, the frequency spread and f₀ 1608a have a logarithmic (log base 10) relationship. In an example that is compliant or compatible with Qi standards, where 80 Khz<f₀<110 Khz, a passive ping frequency may be defined such that 175 KHz<fₚ<210 KHz.

According to certain aspects disclosed herein, frequency spread may be selected as a trade-off between signal-to-noise ratio (SNR) and power consumption or response time. In the example illustrated in FIG. 16, an overly high value for frequency spread may result in lower SNR, while an overly high value for frequency spread may result in high power draw and/or slow response. The optimal balance between SNR and power draw may vary by application. In some implementations, the lowest power and fast scan rate is obtained by setting fₚ 1612 as high as possible while permitting reliable detection of objects given SNR for the system.

The duration of a pulse 1602 can be defined as a number of fractions of a cycle of fₚ1612. In one example, the duration of the passive ping pulse may be set to a half-cycle of fₚ 1612. In another example, the duration of the passive ping pulse may be set to multiple cycles of fₚ 1612. In some implementations, the duration of the passive ping pulse includes enough half-cycles off fₚ 1612 to obtain a current draw in the detectable range of an analog-to-digital converter (ADC) in microprocessor of a charging device. The passive ping pulse may include additional cycles to accommodate the SNR margin. The number of additional cycles may be the subject of a trade-off to increase the SNR, while limiting power and ping time. In one example, where fₚ=190 KHz and f₀=100 KHz, the duration of the passive ping pulse is less than 100 μS.

The repetition rate for pulses 1602 in a pulsed stimulus signal can be determined dynamically when speed of detection is prioritized. In one example, the ADC can be checked to determine when current has fallen back to zero before launching the next pulse 1602. In this manner, a detection circuit can determine that no energy remains in the resonant circuit 1106 (see FIG. 11) from the pulse 1602 before initiating the next pulse 1602. In some implementations, a fixed delay between pulses 1602 may be implemented. In one example, the fixed delay may be configured to be 6 times the longest decay time constant expected or observed in the resonant circuit 1106. In one example, the fixed delay may be configured to provide a one millisecond interval between pulses. The one millisecond ping interval may enable an 18-coil charging pad to be scanned in 18 mS, permitting sub-second device detection. The fixed time approach can be used if further optimization for speed is not necessary. For example, a dynamic ping interval may be used when larger numbers of charging coils are provided in a charging pad.

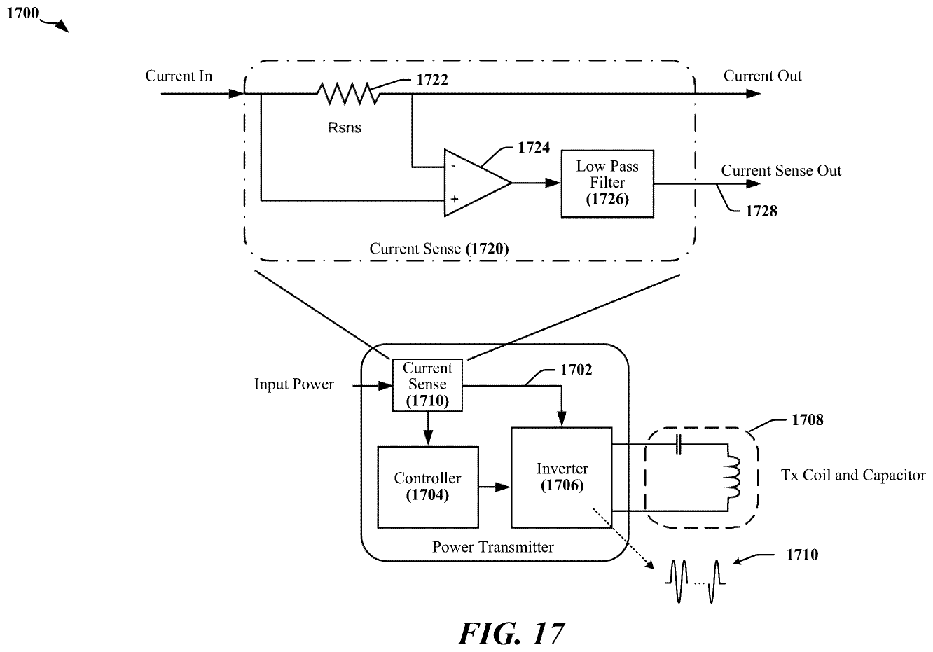

FIG. 17 illustrates a circuit 1700 that may be used to measure response of a resonant circuit in a passive ping procedure. In the illustrated example, the circuit 1700 monitors the power 1702 supplied to an inverter 1706 that produces the pulse 1710. The power 1702 may be measured as current flow to the resonant circuit 1708. In some implementations, power 1702 may be measured as a voltage across the resonant circuit 1708. In the illustrated example, a current sensing circuit 1720 provides measurements to a controller 1704 that configures, initiates and/or triggers pulses 1710 provided to the resonant circuit 1708. In one example, the current sensing circuit 1720 uses a comparator 1724 to measure the voltage across a low-value resistor 1722 in the power supply coupling to the inverter 1706. A low-pass filter 1726 may be used to provide an average or root-mean square value as the output 1728 of the current sensing circuit 1720.

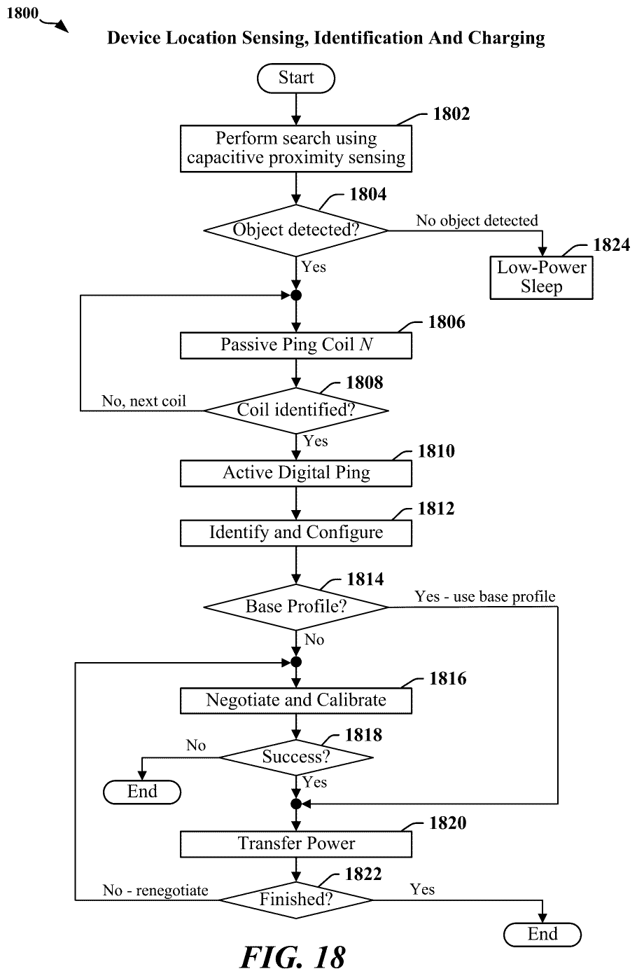

Passive ping procedures may also be coupled with another, reduced-power sensing methodology, such as capacitive sensing. Capacitive sensing or the like can provide an ultra-low power detection method that determines presence or non-presence of an object is in proximity to the charging surface. After capacitive sense detection, a passive ping can be transmitted sequentially or concurrently on each coil to produce a more accurate map of where a potential receiving device and/or object is located. After a passive ping procedure has been conducted, an active ping may be provided in the most likely device locations. An example algorithm for device location sensing, identification and charging is illustrated in FIG. 18.

FIG. 18 is a flowchart 1800 that illustrates a power transfer management procedure involving multiple sensing and/or interrogation techniques that may be employed by a wireless charging device implemented in accordance with certain aspects disclosed herein. The procedure may be initiated periodically and, in some instances, may be initiated after the wireless charging device exits a low-power or sleep state. In one example, the procedure may be repeated at a frequency calculated to provide sub-second response to placement of a device on a charging pad. The procedure may be re-entered when an error condition has been detected during a first execution of the procedure, and/or after charging of a device placed on the charging pad has been completed.

At block 1802, a controller may perform an initial search using capacitive proximity sensing. Capacitive proximity sensing may be performed quickly and with low power dissipation. In one example, capacitive proximity sensing may be performed iteratively, where one or more transmission coils is tested in each iteration. The number of transmission coils tested in each iteration may be determined by the number of sensing circuits available to the controller. At block 1804, the controller may determine whether capacitive proximity sensing has detected the presence or potential presence of an object proximate to one of the transmission coils. If no object is detected by capacitive proximity sensing, the controller may cause the charging device to enter a low-power, idle and/or sleep state at block 1824. If an object has been detected, the controller may initiate passive ping sensing at block 1806.

At block 1806, the controller may initiate passive ping sensing to confirm presence of an object near one or more transmission coils, and/or to evaluate the nature of the proximately located object. Passive ping sensing may consume a similar quantity of power but span a greater of time than capacitive proximity sensing. In one example, each passive ping can be completed in approximately 100 μs and may expend 0.25 μJ. A passive ping may be provided to each transmission coil identified as being of-interest by capacitive proximity sensing. In some implementations, a passive ping may be provided to transmission coils near each transmission coil identified as being of-interest by capacitive proximity sensing, including overlaid transmission coils. At block 1808, the controller may determine whether passive ping sensing has detected the presence of a potentially chargeable device proximate to one of the transmission coils that may be a receiving device. If a potentially chargeable device has been detected, the controller may initiate active digital ping sensing at block 1810. If no potential chargeable device has been detected, passive ping sensing may continue at block 1806 until all of the coils have been tested and/or the controller terminates passive ping sensing. In one example, the controller terminates passive ping sensing after all transmitting coils have been tested. When passive ping sensing fails to find a potentially chargeable device, the controller the controller may cause the charging device to enter a low-power, idle and/or sleep state. In some implementations, passive ping sensing may be paused when a potentially chargeable device is detected so that an active ping can be used to interrogate the potentially chargeable device. Passive ping sensing may be resumed after the results of an active ping have been obtained.

At block 1810, the controller may use an active ping to interrogate a potentially chargeable device. The active ping may be provided to a transmitting coil identified by passive ping sensing. In one example, a standards-defined active ping exchange can be completed in approximately 90 ms and may expend 80 mJ. An active ping may be provided to each transmission coil associated with a potentially chargeable device.

At block 1812, the controller may identify and configure a chargeable device. The active ping provided at block 1810 may be configured to stimulate a chargeable device such that it transmits a response that includes information identifying the chargeable device. In some instances, the controller may fail to identify or configure a potentially chargeable device detected by passive ping, and the controller may resume a search based on passive ping at block 1806. At block 1814, the controller may determine whether a baseline charging profile or negotiated charging profile should be used to charge an identified chargeable device. The baseline, or default charging profile may be defined by standards. In one example, the baseline profile limits charging power to 5 W. In another example, a negotiated charging profile may enable charging to proceed at up to 17 W. When a baseline charging profile is selected, the controller may begin transferring power (charging) at block 1820.

At block 1816, the controller may initiate a standards-defined negotiation and calibration process that can optimize power transfer. The controller may negotiate with the chargeable device to determine an extended power profile that is different from a power profile defined for the baseline charging profile. The controller may determine at block 1818 that the negotiation and calibration process has failed and may terminate the power transfer management procedure. When the controller determines at block 1818 that the negotiation and calibration process has succeeded, charging in accordance with the negotiate profile may commence at block 1820.

At block 1822, the controller may determine whether charging has been successfully completed. In some instances, an error may be detected when a negotiated profile is used to control power transfer. In the latter instance, the controller may attempt to renegotiate and/or reconfigure the profile at block 1816. The controller may terminate the power transfer management procedure when charging has been successfully completed.

The use of passive ping techniques disclosed herein can enable rapid, low-power detection or discovery of devices or objects that have been placed or positioned proximate to a charging surface. A charging device that employs passive ping can benefit from reduced quiescent power draw, increased detection speed, and reduced radiated EMI. A conventional system that uses passive ping detection operates by providing a stimulating pulse that is used to measure a current or voltage value or rate of decay in order to determine a characteristic of the stimulated the network. Conventional systems, for example, strive to detect changes in Q factor of a resonant circuit stimulated by the stimulating pulse. The value of the Q factor may be calculated or estimated base do a comparison of an electrical or electromagnetic signal to a threshold value.

Certain aspects of this disclosure apply to systems that provide a distributed charging surface that may be implemented using two or more modular charging devices to provide physically distributed charging surface portions that can be operated as a single modular charging surface. From an electrical circuit perspective, the components of the distributed charging surface may be electrically coupled or interconnected in the same manner as that of components in a single charging surface implemented using multiple modular charging devices. From a data communication perspective, the components of the distributed charging surface may be logically communicatively coupled or interconnected in the same manner as the components of a single charging surface implemented using multiple modular charging devices. The physical and electrical characteristics of interconnects may differ between a distributed charging surface and a single charging surface implemented using multiple modular charging devices based on length and impedance of interconnects and other physical characteristics of the interconnects. For the purposes of this description the communication and power distribution architectures may be considered to be identical for a distributed charging surface and for a single charging surface implemented using multiple modular charging devices.

In one example, a primary or main controller may be provided to manage and control charging and/or device discovery procedures in a wireless charging system that includes multiple modular charging devices. In some examples, a controller provided in one of the modular charging devices may be configured to serve as the main controller. In some examples, the main controller may be attached to an edge of a charging surface or provided separately from the modular charging devices. In the latter examples, the separated main controller may enable thin charging surfaces to be attached to or embed in an object of furniture or a surface in a vehicle.

The modular charging devices may include control circuits that can be used to monitor, configure and manage charging operations through the respective charging surfaces provided by the modular charging devices. In some instances, the control circuits may include processing devices or switches that enable the control circuits in a first modular charging device to manage and control charging and/or device discovery in a second modular charging device, including where the second modular charging device is spaced apart or otherwise physically separated from the first modular charging device. The control circuits may control flow of charging currents through access to a power source or by directing the charging current to independent groupings of coils provided on multiple charging modules in interconnected charging devices. The control circuits may be configured to define physically independent charging zones that can be managed and operated as a single system. In one example, the independent charging zones may be provided on a surface of a tabletop, shelf, appliance, or other suitable carrier. In another example, the independent charging zones may be deployed in multiple locations within a confined space, such as within a cabin of a car or other vehicle or form of transportation.

A modular or physically-distributed charging surface may be configured to optimize concurrent wireless charging of devices that have a variety of sizes and shapes or that have different sized receiving coils. Concurrent wireless charging of devices may be optimized when a maximum number of devices can be charged simultaneously without compromising speed of charging devices associated with high power consumption. In one example, a wireless charging system may be expected to charge a tablet computer and multiple smaller devices such as a smartwatch or mobile telephone. Optimal charging of the tablet computer may necessitate the use of a large transmitting coil, while smaller transmitting coils may facilitate stacking of physically smaller devices or devices associated with low power consumption by providing a larger number of charging cells within an area of the charging surface.

In one aspect of the disclosure, a mixture of modular or physically-distributed charging surfaces can be connected or coupled to provide different charging zones with different charging cell sizes. In another aspect of the disclosure, certain modular or physically-distributed charging surfaces can include different charging zones with different charging cell sizes. In another aspect of the disclosure, a standalone charging surface can include different charging zones with different charging cell sizes.

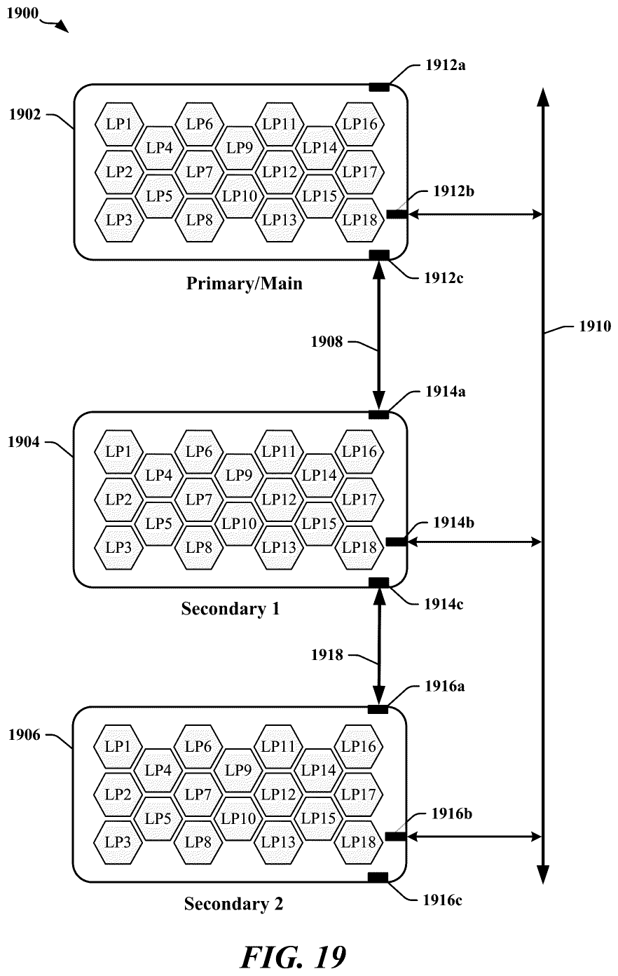

FIG. 19 illustrates an example of a charging system 1900 that includes multiple charging modules 1902, 1904, 1906 provided in accordance with certain aspects of this disclosure. In one example, the charging modules 1902, 1904, 1906 may be physically joined or interconnected to provide a single scalable, modular charging surface such as the modular charging surfaces illustrated in FIGS. 9-10. In some examples, one or more of the charging modules 1902, 1904, 1906 may be remotely located from at least one other charging module 1902, 1904, 1906 to provide a distributed charging surface. The charging system 1900 may include one or more controllers that can communicate with the charging modules 1902, 1904, 1906. In one example, a primary controller may communicate control messages to a secondary controller over a data communication link. In some examples, a primary controller may provide control signals that are used to control charging or detection operations at the charging modules 1902, 1904, 1906. In some examples, the primary controller may control power flow in the charging modules 1902, 1904, 1906. In some examples, the primary controller may provide charging currents to one or more groups of charging coils on the charging modules 1902, 1904, 1906.

Each charging module 1902, 1904, 1906 may include one or more charging cells that encompass one or more power transfer areas. Each power transfer area is substantially planar and centered around an axis that is substantially perpendicular to its a charging surface of its associated charging module 1902, 1904, 1906. In some examples, each of the charging modules 1902, 1904, 1906 can operate as a standalone wireless charger that includes controllers and power management circuits. The standalone wireless charger may be configured to detect chargeable devices, generate charging configurations and provide a charging current to one or more charging cells identified by the charging configurations.

In some examples, certain charging modules 1904, 1906 operate as secondary devices that have limited capability. In one example, the limited-capability charging modules 1904, 1906 receive charging currents through dedicated connectors and the charging currents are directed to one or more charging cells through fixed electrical paths or through a switch that may be controlled by a primary charging module 1904 or other centralized or distributed controller. In another example, the limited-capability charging modules 1904, 1906 may have a controller capable of selecting charging cells to receive a charging current and to provide the charging current to the selected charging cells. In the latter example, some limited-capability charging modules 1904, 1906 may be configured to exchange messages with one or more other charging modules 1902, 1904, 1906 in the system, or exchange messages with a chargeable device. In some instances, the limited-capability charging modules 1904, 1906 may be capable of conducting searches for chargeable devices or may be configured to participate in a search for chargeable devices controlled by a primary charging module 1904 or other centralized or distributed controller.

The charging system 1900 can be constructed from interconnected charging modules 1902, 1904, 1906. The charging modules 1902, 1904, 1906 may have a same or different size or shape. The charging modules 1902, 1904, 1906 may have a same or different number or configuration of power transmitting coils. In the illustrated example, the charging modules 1902, 1904, 1906 have similar size, shape and transmitting coil configuration, although the charging modules 1902, 1904, 1906 have a same or different configuration in other implementations.

In certain examples, each of the charging modules 1902, 1904, 1906 includes one or more connectors 1912a, 1912b, 1912c, 1914a 1914b, 1914c, 1916a 1916b, 1916c, which may couple the charging modules 1902, 1904, 1906 to a multi-drop serial bus 1910 or support a daisy chain connection 1908, 1918. In one example, the multi-drop serial bus 1910 is configured as a serial bus that enables the charging modules 1902, 1904, 1906 to exchange command and control messages. In one example, the serial bus is operated in accordance with Improved Inter-Integrated Circuit (I3C) protocols, Controller Area Network (CAN) bus protocols, Local Interconnected Network (LIN) bus protocols, or the like. In some instances, the charging modules 1902, 1904, 1906 may communicate wirelessly. In some implementations, the daisy chain connection 1908, 1918 is used to distribute charging current among the charging modules 1902, 1904, 1906. The daisy chain connection 1908, 1918 may also be used for exchanging command and control messages.

In one example, one or more of the charging modules 1902, 1904, 1906 can serve as a primary device and may include a processing circuit configured to manage operation of one or more charging modules 1902, 1904, 1906 that is operated as a secondary device. In the illustrated example, two charging modules 1904, 1906 operate as secondary devices and may include processing circuits configured to communicate over the multi-drop serial bus 1910 in order to receive commands from the primary charging module 1902 and to report feedback information to the primary charging module 1902. Secondary charging modules 1902, 1904, 1906 may include or control a driver circuit that provides a flow of a charging current provided through the daisy chain connection 1908, 1918, when the charging current is provided by a current source through the operation of the primary charging module 1902.

The secondary charging modules 1904, 1906 may cooperate with the primary charging module 1902 to discover, enumerate and configure the combination of charging modules 1902, 1904, 1906 provided in the charging system 1900. In one example, the secondary charging modules 1904, 1906 participate in a serial bus arbitration process to identify themselves to the primary charging module 1902 and/or to obtain unique addresses. In another example, the secondary charging modules 1904, 1906 may be preconfigured with at least a secondary address that the primary charging module 1902 can use to address each secondary charging module 1904, 1906 through the multi-drop serial bus 1910. The primary charging module 1902 may use the multi-drop serial bus 1910 to configure the secondary charging modules 1904, 1906, interrogate the secondary charging modules 1904, 1906 for capability, charging cell size, number and configuration as well as status information. The primary charging module 1902 may use the multi-drop serial bus 1910 to configure the secondary charging modules 1904, 1906 for one or more charging operations.

In some implementations, each of the charging modules 1902, 1904, 1906 can be independently connected to a power supply that can be used to provide and configure a charging current. In one example, the charging modules 1902, 1904, 1906 may include an inverter or switching power supply configurable to produce an alternating current (AC) that has frequency suitable for wireless charging. In some implementations, each of the charging modules 1902, 1904, 1906 may be coupled to a multi-purpose communication bus that is used by other devices or systems (in an automobile for example). In the latter implementations, the primary charging module 1902 may also be a controlling entity on the bus.

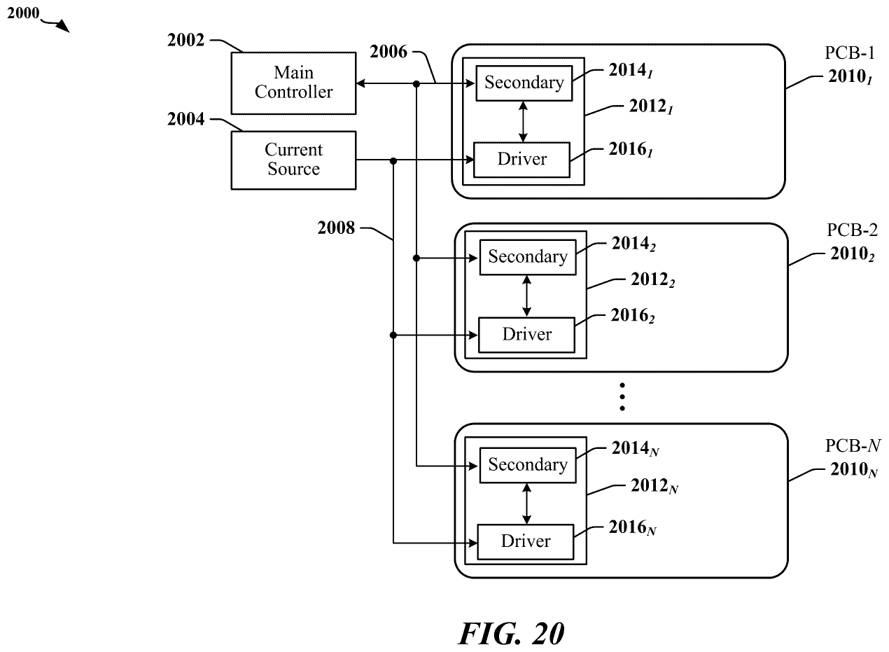

FIG. 20 illustrates a first example of a combined control circuit 2000 in a charging system provided in accordance with certain aspects disclosed herein. Each charging module 2010_{I}-2012_{N} includes a processing circuit 2012_{I}-2012_{N} that is configured and controlled by a main controller 2002 to manage operation of its respective charging module 2010_{I}-2012_{N}. In one example, each processing circuit 2012_{I}-2012_{N} includes a secondary circuit 2014_{I}-2014_{N} configured to communicate over a serial bus 2006 in order to receive commands and report feedback information to the main controller 2002. The secondary circuit 2014_{I}-2014_{N} may control a driver circuit 2016_{I}-2016_{N} that controls flow of a charging current provided through an interlink 2008 by a current source 2004.

The secondary circuits 2014_{I}-2014_{N} may cooperate with the main controller 2002 to discover, enumerate and configure the combination of charging modules 2010_{I}-2012_{N} provided in the modular charging surface. In one example, the secondary circuits 2014_{I}-2014_{N} participate in an arbitration process to identify themselves to the main controller 2002 and/or to obtain unique addresses. In another example, the secondary circuits 2014_{I}-2014_{N} may be preconfigured with at least a secondary address that the main controller 2002 can use to address each secondary circuit 2014_{I}-2014_{N} through the serial bus 2006. The main controller 2002 may use the serial bus 2006 to configure the secondary circuits 2014_{I}-2014_{N}, interrogate the secondary circuits 2014_{I}-2014_{N} for capability and status information, and configure the secondary circuits 2014_{I}-2014_{N} for one or more charging operations.

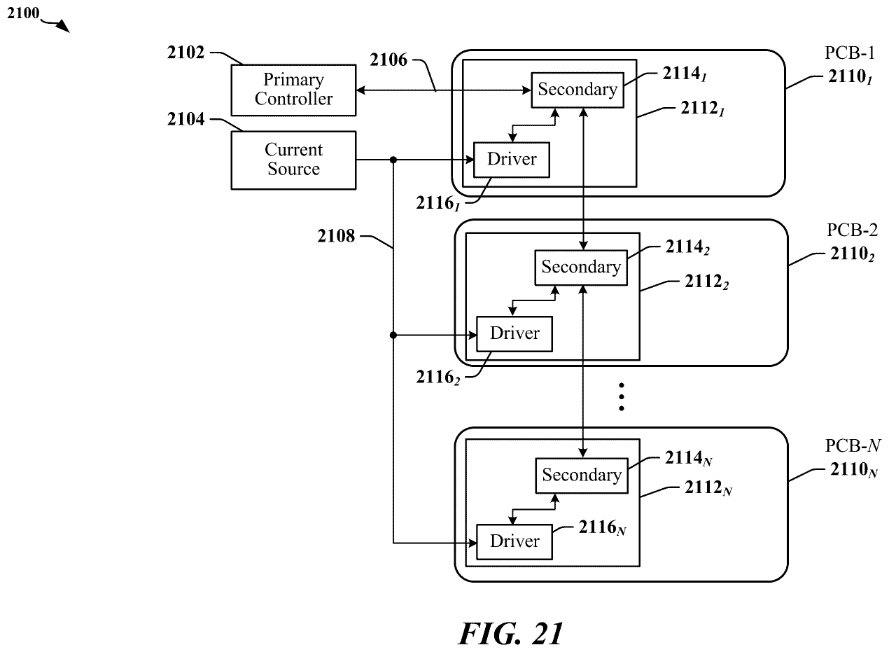

FIG. 21 illustrates a second example of a combined control circuit 2100 that may be provided in a charging system provided in accordance with certain aspects disclosed herein. Each charging module 2110_{I}-2112_{N} includes a processing circuit 2112_{I}-2112_{N} that is configured and controlled by a main controller 2102 to manage operation of its respective charging module 2110_{I}-2112_{N}. In one example, each processing circuit 2112_{I}-2112_{N} includes a secondary circuit 2114_{I}-2114_{N} configured to communicate over a serial bus 2106 in order to receive commands and report feedback information to the main controller 2102. The secondary circuit 2114_{I}-2114_{N} may control a driver circuit 2116_{I}-2116_{N} that controls flow of a charging current provided through an interlink 2108 by a current source.

The secondary circuits 2114_{I}-2114_{N} may cooperate with the main controller 2102 to discover, enumerate and configure the combination of charging modules 2110_{I}-2112_{N} provided in the modular charging surface. In the illustrated example, the secondary circuits 2114_{I}-2114_{N} are connected in a daisy chain fashion, whereby the main controller 2102 connects with and configures a first secondary circuit 2114_{I}, which then couples the second secondary circuit 2114₂ to the main controller 2102 through the serial bus 2106. The main controller 2102 configures the second secondary circuit 2114₂ and the process continues until the last secondary circuit 2114_{N} has been configured. In another example, the secondary circuits 2114_{I}-2114_{N} may be preconfigured with at least a secondary address that the main controller 2102 can use to address each secondary circuit 2114_{I}-2114_{N} through the serial bus 2106.

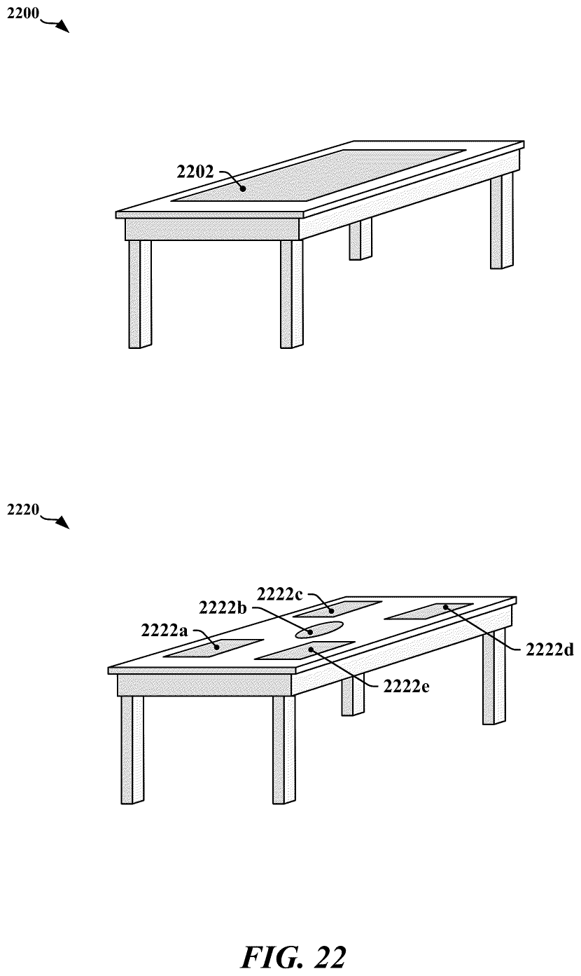

FIG. 22 illustrates an example use of charging devices to provide one or more charging areas on an item of furniture in accordance with certain aspects of this disclosure. In certain implementations, the charging surface is located on an upper surface of a countertop. The charging surface may correspond to a projection of the charging surface of a wireless charging device through the countertop. The charging surface can be expected to occupy an area that closely corresponds to the dimensions of the charging surface of the wireless charging device.

The illustrated charging devices may be provided in a desk, table 2200, 2220, workbench, countertop including bar and kitchen worksurfaces, or the like. The charging devices may be provided in other items including armrests of an armchair, armrests in an automobile, windowsills in a room, consoles in a vehicle, tray tables in an airplane and other examples. The example of a table 2200, 2220 is used in FIG. 22 for clarity and to facilitate description of certain aspects of a wireless charging system. A first table 2200 is equipped with a large charging surface 2202 that may be assembled from numerous charging modules that are arranged and configured to provide the large charging surface 2202. A second table 2220 is equipped with multiple charging surfaces 2222a-2222e that can have different sizes or shapes. Each of the charging surfaces 2222a-2222e may be implemented using one or more charging modules constructed in accordance with the examples illustrated herein. In some examples, at least one of the charging modules may differ from other charging modules in overall size or shape or by the number, size or configuration of included charging coils.

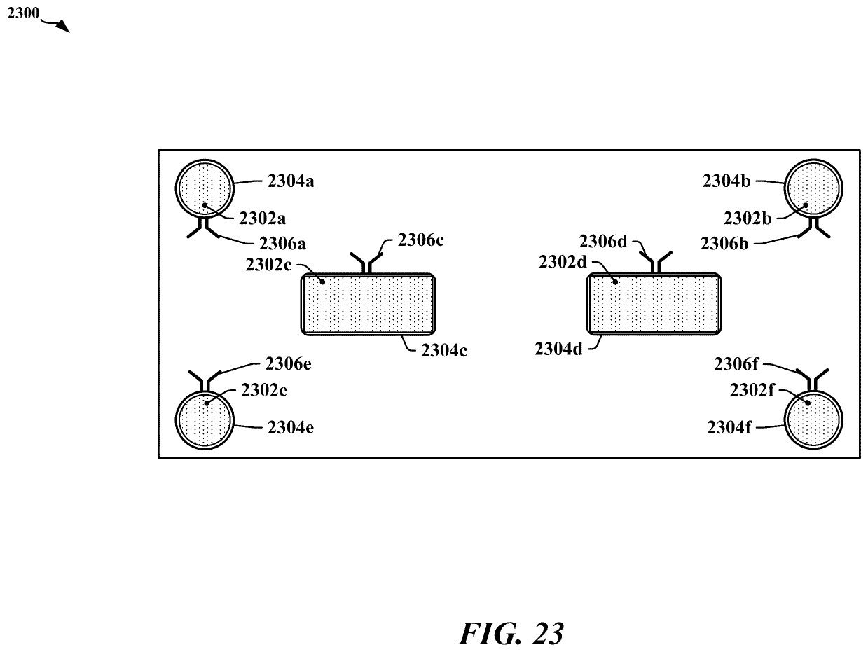

FIG. 23 illustrates an example of a modular charging device layout on a surface 2300 of a table, desk, workbench, countertop, bar top, kitchen worksurface, or other item of furniture in accordance with certain aspects of this disclosure. Modular charging devices may be provided in other items including armrests of an armchair, armrests in an automobile, windowsills in a room, consoles in a vehicle, tray tables in an airplane and other examples. The modular charging devices are deployed to provide multiple charging areas 2302a-2302f across the surface 2300 of the table, desk, workbench, countertop, bar top, kitchen worksurface, or other item of furniture. In some examples, at least one of the charging modules may differ from other charging modules in overall size or shape or by the number, size or configuration of included charging coils.

In the illustrated example, each of the charging areas 2302a-2302f is circumscribed by an indicator line 2304a-2304f that follows the shape of the corresponding charging area 2302a-2302f. In some implementations, the indicator lines 2304a-2304f may be formed on the surface of the table, desk, workbench, bar top, kitchen worksurface, or other item of furniture. The term “indicator line” as used herein applies to a straight or curved line that follows at least a portion of the perimeter of a charging area 2302a-2302f. In one example, one or more indicator lines may be provided to encircle, encompass or circumscribe a charging area 2302a-2302f. In some instances, an indicator line may fully enclose a shape such as a circle, oval square rectangle or other regular or irregular shape. In some instances, an indicator line may be partially illuminated such that some points, dots or sections of the indicator line are illuminated and other points, dots or sections of the indicator line are not illuminated. Indicator lines are depicted in the drawings using a solid, dotted or dashed line regardless of whether the corresponding indicator line can be illuminated along the entirety of its length or illuminated at certain points, dots or sections of the indicator line.

In certain implementations, the indicator lines 2304a-2304f may be obtained by projecting light onto a lower surface of the table, desk, workbench, bar top, kitchen worksurface, or other item of furniture such that some portion of the light penetrates the surface. In some implementations, a countertop may be fabricated from stone, ceramic or other material that is translucent or capable of conducting light. The light may produce illuminated shapes such as lines, dots, or some combination of lines and dots on the countertop to indicate one or more active charging areas. In one example light generated by LED lamps or strips may penetrate 2 centimeters (2 cm) or more through a stone countertop. In other examples, the density of the stone may significantly limit the light conducted from a lower surface to the upper surface such that the thickness of the countertop proximate to the indicator lines 2304a-2304f is less than 2 cm.

It is contemplated that, in some instances, a transparent, semitransparent, translucent or diaphanous material may be inlaid or embedded in an otherwise opaque countertop material to form the indicator lines 2304a-2304f. In some instances, an inlay provided in the otherwise opaque countertop may have light refracting and/or light diffusing properties such that the indicator lines 2304a-2304f may be formed by conducting light through the inlay. In some instances, the inlay may comprise a broken line of holes or channels that are filled with an inlaid or embedded material.

In some implementations, light sources such as LED lamps or strips of LED lamps can be used to illuminate the indicator lines 2304a-2304f. The LED lamps may be configured to emit colored light that is visible to a user during placement and/or charging of a device through the charging surface. In some examples, light from the LED lamps is carried through light pipes, light guides and/or light diffusers to an upper surface of the table, desk, workbench, bar top, kitchen worksurface, or other item of furniture. In some implementations, the light pipes, light guides or light diffusers may be used alone or in combination to provide the visible indicator line 2304a-2304f on the table, desk, workbench, bar top, kitchen worksurface, or other item of furniture. In these latter implementations, the visible indicator line 2304a-2304f may be illuminated when a chargeable device is detected nearby, or may be in an always on state. The visible indicator line 2304a-2304f may present a first color to indicate availability of charging circuits and may present a second color to indicate that the charging surface is in use. In some instances, the color of the visible indicator line 2304a-2304f may indicate whether charging is in progress or completed, or whether an error has occurred. The error may relate to misalignment of the chargeable device, presence of a foreign object, an overheating condition or the like.

According to certain aspects of this disclosure, a wireless tag may communicate in an RF band at or near 900 MHz (UHF) and/or in accordance with industry standard air interface protocols, including ISO-13092 at UHF frequencies, FeliCa, ISO-14443, the Global System for Mobile Communications Association (GSMA) NFC standards, and various standards and protocols defined by the NFC Forum. The ISO-14443 standard is defined by a technical committee of the International Organization for Standardization (ISO) and the International Electrotechnical Commission (IEC) and may be used for contactless transaction including transactions involving credit cards, for example. Other standards, protocols and frequencies may be used in a wireless tag, including ZigBee, Bluetooth, IEEE 802.11x and other proprietary protocols.

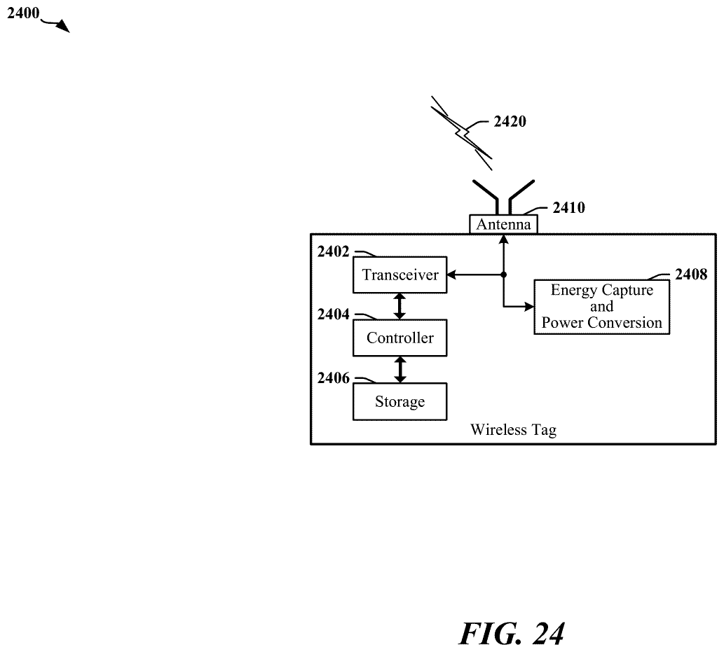

FIG. 24 illustrates an example of a wireless tag 2400 that may be adapted in accordance with certain aspects of this disclosure. The wireless tag 2400 may be implemented in single IC device that comprises a low-power transceiver 2402, a controller 2404 and storage 2406. The low-power transceiver 2402 may be configured for transmitting and receiving wireless communication using an antenna 2410. The antenna 2410 may be provided external to the IC device. The antenna 2410 may be disposed upon or attached to the IC device, fabricated in the IC device, painted on the IC device or located apart from, or proximately to the IC device. In some implementations, the antenna 2410 may be formed as a loop antenna or a dipole antenna. The wireless communication may facilitate an exchange of information, typically according to a standards-based transmission protocol that may specify formats for transmitting the information. The information may include command and data elements and the protocol may specify sequences for exchange of passwords, encryption keys and other identifying information.

Certain identifying information, encryption keys, unique identifiers and preformed message payloads may be loaded into the storage 2406 during manufacturing, initialization or application-controlled configuration of the wireless tag 2400. In one example, unique identifiers, passwords and/or encryption keys can be used to authenticate wireless communication. In some implementations, wireless communication may be unauthenticated and unencrypted, and information exchanged through wireless communication may identify one or more specific actions to be taken by the wireless controller 2404, and/or to select a preformed message payload to be transmitted by the wireless tag 2400 in response to interrogation through a received wireless signal 2420.

The wireless tag 2400 may comprise energy capture and power conversion circuits 2408. In some implementations, the energy capture and power conversion circuits 2408 may be wholly provided within the IC device that includes the low-power transceiver 2402, controller 2404 and storage 2406. In some implementations, a portion of the energy capture and power conversion circuits 2408 is provided within the IC device that includes the low-power transceiver 2402, controller 2404 and storage 2406, with certain components such as large capacitors being located externally. In some implementations, substantially all of the energy capture and power conversion circuits 2408 is provided externally. In some implementations, the wireless tag 2400 may be powered by an external power source or battery.

The energy capture and power conversion circuits 2408 may include an energy harvesting circuit configured to divert some portion of a current induced in the antenna 2410 by the received wireless signal 2420. The energy capture and power conversion circuits 2408 may rectify the received wireless signal 2420 and may provide a direct current (DC) to an energy storage circuit. In some instances, the energy storage circuit comprises one or more capacitors. In some implementations, the energy capture and power conversion circuits 2408 comprises power conversion circuits that include one or more DC-DC converters. In some implementations, a buck-boost converter circuit may be used to selectively increase or decrease the magnitude of the voltage of a power output of the energy capture and power conversion circuits 2408. In some implementations, a high-efficiency charge pump circuit may be used to selectively increase or decrease the magnitude of the voltage of the power output of the energy capture and power conversion circuits 2408.

With reference again to FIG. 23 a wireless charging system that provides charging zones or areas on a surface 2300 of a table, desk, workbench, countertop, bar top, kitchen worksurface, or other item of furniture may be configured to detect the presence of an object passing over the surface 2300. Detection may be accomplished using one or more techniques or technologies. In one example, passive ping technology may be used to detect presence of an object near a countertop or other charging surface. The object may not be close enough to a charging surface to efficiently receive power, and the amplitude of passive pings may be increased to enable changes in resonance to be detected as an indication of presence of an object. In another example, an NFC or RFID interrogation signal may be transmitted or received at the charging surface. The charging surface may be equipped with an NFC or RFID radio that can transmit interrogation signals and listen for responses or detect interrogation signals that may originate from a chargeable device.

In some instances, a mobile telephone may be configured to transmit or receive interrogation signals. In another example, the wireless charging system may be configured to broadcast an omnidirectional locator signal or a locator signal that radiates through an antenna 2306a-2306d into an area above the surface 2300, or in which a chargeable device may be expected to be found. The wireless charging system may be further configured to listen for reflections of the transmitted signal through one or more of the antennas 2306a-2306d. In some implementations, the antennas 2306a-2306d may be implemented using power transmitting coils. In some implementations, the antennas 2306a-2306d are provided independently of power transmitting circuits. In some implementations, the locator signal is transmitted at a higher frequency than the frequency of electromagnetic flux provided during wireless charging events.

In some implementations, the wireless charging system may determine the location of an object in three-dimensional space by triangulation. In one example, the power of a reflected locator signal measured at multiple antennas 2306a-2306d may be compared to calculate or estimate relative proximity to the receiving antennas. In one example, each of the antennas 2306a-2306d may be associated with a specific charging module located on the surface of a countertop, and it may be sufficient to obtain a coarse estimation of relative location in order to illuminate a light pattern around the closest charging surface.

In some implementations, the wireless charging system may determine the location of an object in three-dimensional space through the use of doppler shifts. The use of doppler shift can be particularly useful when a chargeable device is in motion. In one example, a user may pass or wave the chargeable device over a portion of a countertop in order to activate the light pattern around a charging surface. The user can then place the charging device within the perimeter of the light pattern in order to enable detection and identification of the chargeable device in order to develop a charging configuration and/or to commence charging. When doppler detection is not available, or when doppler detection produces inconclusive results, repeated triangulations can be used to characterize motion of the object or chargeable device.

In certain implementations, a wireless charging system associated with a planar surface includes one or more charging areas associated with a wireless charging device, one or more wireless transmitters, one or more wireless receivers configured to receive reflections of a signal transmitted by at least one wireless transmitter, and a controller. The controller may be configured to determine that the reflections are received from an object moving across and displaced from the surface. The controller may cause one or more indicator lines to be illuminated in order to identify a physical location of a charging area available to wirelessly charge a chargeable device.

In one example, the controller is configured to detect a doppler shift in the reflections with respect to the signal transmitted by at least one wireless transmitter, and determine presence of the object based on the doppler shift. In another example, the controller is configured to triangulate reflections of signals transmitted by one or more wireless transmitters, and determine presence of the object based on triangulation.

In certain implementations, the controller is configured to detect changes in signals provided by one or more infrared sensors. The infrared sensors may be deployed on or around the table, desk, workbench, countertop, bar top, kitchen worksurface, or other item of furniture. The infrared sensors may include a passive infrared sensor that is configured to provide a signal representative of infrared light radiating from objects in a field of view of the infrared sensor. In some instances, a single infrared sensor with a sufficiently large field of view may be sufficient to cover the three-dimensional space directly above the table, desk, workbench, countertop, bar top, kitchen worksurface, or other item of furniture. One of the infrared sensors may be incorporated in a security system or a device that is part of a home automation system.

In some implementations, a security system and/or home automation system communicates with the wireless charging system and the security system and/or home automation system may send alerts, messages or commands to the wireless charging system upon detection of motion in an area in which the wireless charging system is located. In some implementations, the security system and/or home automation system may send alerts, messages or commands to the wireless charging system when the security system and/or home automation system receives commands from users, including persons present in the area in which the wireless charging system is located. Commands received from a security system and/or home automation system may be converted from verbal commands given by persons present in the area in which the wireless charging system is located.

In some implementations, a security system or home automation system that is configured to detect movement in the vicinity of the wireless charging system may signal the wireless charging system that a person is present, prompting the wireless charging system to illuminate a light pattern around one or more available charging surfaces. The security system or home automation system may employ various types of sensors to detect presence of a person in the vicinity of the table, desk, workbench, countertop, bar top, kitchen worksurface, or other item of furniture. In one example, the security system or home automation system may use a microwave doppler motion detector to control lights. In another example, the security system or home automation system may detect door openings or changes in ambient lighting.

In certain implementations, the signal transmitted by at least one wireless transmitter comprises an infrared signal. The infrared signal may be emitted by one or more LEDs. The LEDs may emit laser light. In certain implementations, the signal transmitted by at least one wireless transmitter comprises a radio frequency signal. In certain implementations, the signal transmitted by at least one wireless transmitter comprises a near field communications or RFID signal. In certain implementations, the signal transmitted by at least one wireless transmitter comprises an acoustic signal. In certain implementations, the signal transmitted by at least one wireless transmitter comprises is transmitted in a microwave band.

In certain examples, the changes in the electrical or magnetic characteristic associated with the two or more power transmitting coils occur when the chargeable device is moved across and displaced from the planar surface. The one or more charging areas may be embedded in the planar surface. The one or more charging areas may be located behind the planar surface.

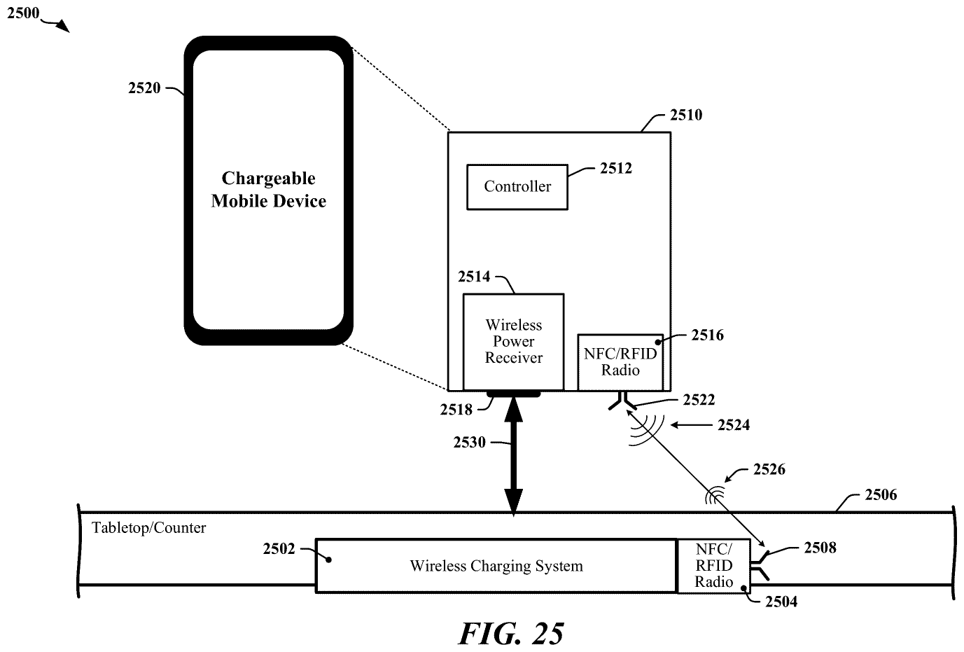

FIG. 25 illustrates an example of a wireless charging system 2500 in which a wireless charging circuit 2502 and one or more NFC/RFID radios 2504 may be provided within and/or attached to a tabletop, countertop or other work surface 2506. In some implementations, the wireless charging system 2500 can be configured to use the NFC/RFID radio 2504 to transmit an interrogation signal in order to detect a nearby mobile device 2520 that can respond to the interrogation signal. In some implementations, the wireless charging system 2500 can be configured to use the NFC/RFID radio 2504 to detect an interrogation signal transmitted by the mobile device 2520 when the mobile device 2520 is waved or passed across the tabletop, countertop or other work surface 2506 or when the mobile device 2520 is held near the tabletop, counter or other work surface 2506.

The mobile device 2520 may have a processing circuit 2510 that includes a controller 2512 or other processor and that further includes, or is coupled to a wireless power receiver 2514 and an RFID/NFC radio 2516. The mobile device 2520 may be a cellular telephone, a smartphone, a multimedia device, a video device, a digital audio player (e.g., MP3 player), a camera, an entertainment device, a wearable computing device (e.g., a smart watch, a health or fitness tracker, eyewear, etc.), an appliance, a sensor, a security device, a drone, a multicopter, or any other similar functioning device.

The wireless power receiver 2514 may include, or be coupled to a receiving coil 2518 that is configured to generate a charging current in response to electromagnetic flux 2530 received from the wireless charging circuit 2502. The receiving coil 2518 can function as an antenna that is tuned to the frequency of the electromagnetic flux 2530. The RFID/NFC radio 2516 may be configured to transmit and receive signals 2524, 2526 through the NFC/RFID radio antenna 2522 at frequencies defined by RFID, NFC or other standards and protocols. In some implementations, the receiving coil 2518 can perform the functions of the NFC/RFID radio antenna 2522. The NFC/RFID radio 2504 typically includes an antenna 2508 and may operate as a passive or active wireless tag.

In certain implementations, a processor or controller associated with a wireless charging circuit 2502 responds to an interrogating signal 2524 received through the NFC/RFID radio 2504 by illuminating one or more indicator lines to identify a physical location of a charging area available to wirelessly charge the mobile device 2520. The processor or controller may cause the NFC/RFID radio 2504 to respond to the interrogating signal 2524 by transmitting a response signal 2526. The response may include a predefined message. In one example, the predefined message may cause the mobile device 2520 to display information pertinent to the environment context or usage of the wireless charging system 2500. In one example, the information may be displayed through an application installed on the mobile device 2520. In another example, the information may be accessed through a website indicated by the predefined message transmitted in the response signal 2526. In some instances, the information displayed in response to the NFC/RFID radio 2504 may include or be related to user instructions or troubleshooting.

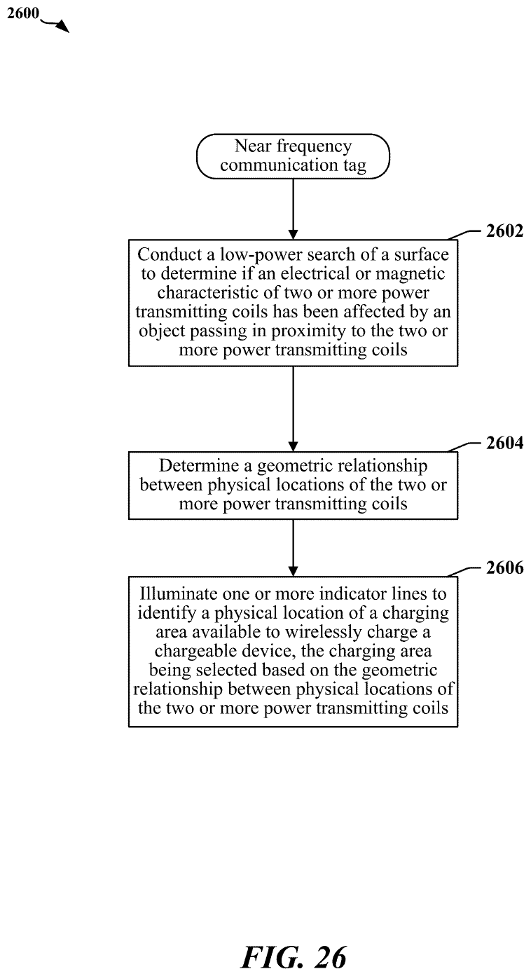

FIG. 26 is flowchart 2600 illustrating one example of a method for detecting an object near a charging surface of a wireless charging device. At block 2602, a low-power search of a surface is conducted to determine if an electrical or magnetic characteristic of two or more power transmitting coils has been affected by an object passing in proximity to the two or more power transmitting coils. At block 2604, a geometric relationship is determined between physical locations of the two or more power transmitting coils. At block 2606, one or more indicator lines are illuminated to identify a physical location of a charging area available to wirelessly charge a chargeable device. The charging area may be selected based on the geometric relationship between physical locations of the two or more power transmitting coils.

In one example, a pulsed signal is provided to each of the plurality of power transmitting coils, and change in resonance associated with each of the two or more power transmitting coils may be detected based on the pulsed signal. Each pulse in the pulsed signal may include a plurality of cycles of a clock signal.

In one example, the changes in the electrical or magnetic characteristic are detected in three or more power transmitting coils in the plurality of power transmitting coils. The three or more power transmitting coils may be located along a substantially straight line. The three or more power transmitting coils may be located along an arc of an ellipse. In one example, the changes in the electrical or magnetic characteristic comprise a change in capacitance in a resonant circuit.

In one example, the changes in the electrical or magnetic characteristic associated with the two or more power transmitting coils occur when the chargeable device is moved across and displaced from a surface of a countertop or table. One or more charging areas may be embedded in the surface of the countertop or table. One or more charging areas are located under the surface of the countertop or table.

### Example of a Processing Circuit

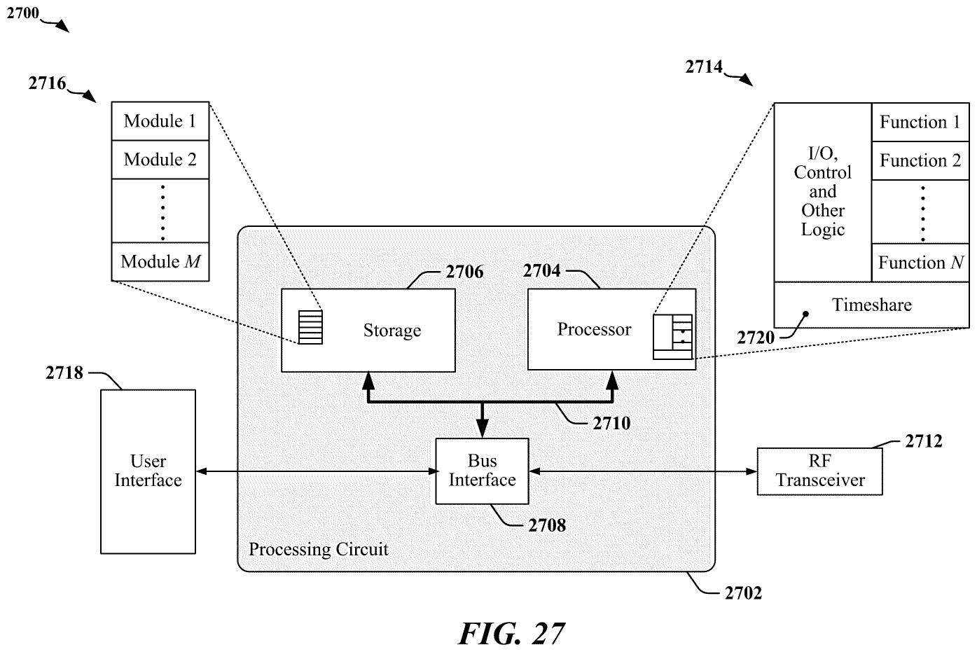

FIG. 27 is a diagram illustrating an example of a hardware implementation for an apparatus 2700 that may be incorporated in a charging device or in a receiving device that enables a battery to be wirelessly charged. In some examples, the apparatus 2700 may perform one or more functions disclosed herein. In accordance with various aspects of the disclosure, an element, or any portion of an element, or any combination of elements as disclosed herein may be implemented using a processing circuit 2702. The processing circuit 2702 may include one or more processors 2704 that are controlled by some combination of hardware and software modules. Examples of processors 2704 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2704 may include specialized processors that perform specific functions, and that may be configured, augmented or controlled by one of the software modules 2716. The one or more processors 2704 may be configured through a combination of software modules 2716 loaded during initialization, and further configured by loading or unloading one or more software modules 2716 during operation.

In the illustrated example, the processing circuit 2702 may be implemented with a bus architecture, represented generally by the bus 2710. The bus 2710 may include any number of interconnecting buses and bridges depending on the specific application of the processing circuit 2702 and the overall design constraints. The bus 2710 links together various circuits including the one or more processors 2704, and storage 2706. Storage 2706 may include memory devices and mass storage devices, and may be referred to herein as computer-readable media and/or processor-readable media. The storage 2706 may include transitory storage media and/or non-transitory storage media.

The bus 2710 may also link various other circuits such as timing sources, timers, peripherals, voltage regulators, and power management circuits. A bus interface 2708 may provide an interface between the bus 2710 and one or more transceivers 2712. In one example, a transceiver 2712 may be provided to enable the apparatus 2700 to communicate with a charging or receiving device in accordance with a standards-defined protocol. Depending upon the nature of the apparatus 2700, a user interface 2718 (e.g., keypad, display, speaker, microphone, joystick) may also be provided, and may be communicatively coupled to the bus 2710 directly or through the bus interface 2708.

A processor 2704 may be responsible for managing the bus 2710 and for general processing that may include the execution of software stored in a computer-readable medium that may include the storage 2706. In this respect, the processing circuit 2702, including the processor 2704, may be used to implement any of the methods, functions and techniques disclosed herein. The storage 2706 may be used for storing data that is manipulated by the processor 2704 when executing software, and the software may be configured to implement any one of the methods disclosed herein, including the method illustrated by the flowchart in FIG. 26.

One or more processors 2704 in the processing circuit 2702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2706 or in an external computer-readable medium. The external computer-readable medium and/or storage 2706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2706 may also include, by way of example, a carrier wave, a transmission line, and any other suitable medium for transmitting software and/or instructions that may be accessed and read by a computer. Computer-readable medium and/or the storage 2706 may reside in the processing circuit 2702, in the processor 2704, external to the processing circuit 2702, or be distributed across multiple entities including the processing circuit 2702. The computer-readable medium and/or storage 2706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2706 may maintain software maintained and/or organized in loadable code segments, modules, applications, programs, etc., which may be referred to herein as software modules 2716. Each of the software modules 2716 may include instructions and data that, when installed or loaded on the processing circuit 2702 and executed by the one or more processors 2704, contribute to a run-time image 2714 that controls the operation of the one or more processors 2704. When executed, certain instructions may cause the processing circuit 2702 to perform functions in accordance with certain methods, algorithms and processes described herein.

Some of the software modules 2716 may be loaded during initialization of the processing circuit 2702, and these software modules 2716 may configure the processing circuit 2702 to enable performance of the various functions disclosed herein. For example, some software modules 2716 may configure internal devices and/or logic circuits 2724 of the processor 2704, and may manage access to external devices such as a transceiver 2712, the bus interface 2708, the user interface 2718, timers, mathematical coprocessors, and so on. The software modules 2716 may include a control program and/or an operating system that interacts with interrupt handlers and device drivers, and that controls access to various resources provided by the processing circuit 2702. The resources may include memory, processing time, access to a transceiver 2712, the user interface 2718, and so on.

One or more processors 2704 of the processing circuit 2702 may be multifunctional, whereby some of the software modules 2716 are loaded and configured to perform different functions or different instances of the same function. The one or more processors 2704 may additionally be adapted to manage background tasks initiated in response to inputs from the user interface 2718, the transceiver 2712, and device drivers, for example. To support the performance of multiple functions, the one or more processors 2704 may be configured to provide a multitasking environment, whereby each of a plurality of functions is implemented as a set of tasks serviced by the one or more processors 2704 as needed or desired. In one example, the multitasking environment may be implemented using a timesharing program 2720 that passes control of a processor 2704 between different tasks, whereby each task returns control of the one or more processors 2704 to the timesharing program 2720 upon completion of any outstanding operations and/or in response to an input such as an interrupt. When a task has control of the one or more processors 2704, the processing circuit is effectively specialized for the purposes addressed by the function associated with the controlling task. The timesharing program 2720 may include an operating system, a main loop that transfers control on a round-robin basis, a function that allocates control of the one or more processors 2704 in accordance with a prioritization of the functions, and/or an interrupt driven main loop that responds to external events by providing control of the one or more processors 2704 to a handling function.

In some examples, the apparatus 2700 is included in, or operates as a wireless charging system that has a battery charging power source coupled to a charging circuit, a plurality of charging cells and one or more processors 2704. The plurality of charging cells may be configured to provide one or more charging surfaces that may be physically separated. At least one coil may be configured to direct an electromagnetic field through a charge transfer area of each charging cell. In one example, the charging system includes a plurality of transmitting coils arranged in a pattern therein. The plurality of transmitting coils may include Litz coils and may define a charging surface.

In one implementation, a charging system provides a charging surface comprising one or more charging areas associated with a wireless charging device, a plurality of power transmitting coils apportioned among the one or more charging areas and a controller. The controller may be configured to conduct a low-power search of the charging surface to determine if an electrical or magnetic characteristic of two or more power transmitting coils has been affected by an object passing in proximity to the two or more power transmitting coils. The controller may be further configured to determine a geometric relationship between physical locations of the two or more power transmitting coils. The controller may be further configured to illuminate one or more indicator lines to identify a physical location of a charging area available to wirelessly charge a chargeable device. The physical location may be selected based on the geometric relationship between physical locations of the two or more power transmitting coils. In some instances, the charging system includes one or more charging modules coupled to a surface of a countertop or table. In some instances, the charging system includes one or more charging modules embedded in a surface of a countertop or table.

In some examples, the controller is further configured to provide a pulsed signal to each of a plurality of power transmitting coils when conducting the low-power search, wherein each pulse in the pulsed signal comprises a plurality of cycles of a clock signal. A change may be detected in resonance associated with each of the two or more power transmitting coils based on response to the pulsed signal.

In some examples, changes in the electrical or magnetic characteristic are detected in three or more power transmitting coils, and wherein the three or more power transmitting coils are located along a substantially straight line. In some examples, changes in the electrical or magnetic characteristic are detected in three or more power transmitting coils. The three or more power transmitting coils may be located along an arc of an ellipse or circle. In some examples, changes in the electrical or magnetic characteristic include a change in capacitance in a resonant circuit. In some examples, changes in the electrical or magnetic characteristic associated with the two or more power transmitting coils occur when the chargeable device is moved across and displaced from a surface.

In one implementation, a charging system includes one or more charging areas associated with a wireless charging device, one or more wireless transmitters, one or more wireless receivers and a controller. The wireless receivers may be configured to receive reflections of a signal transmitted by at least one wireless transmitter. The controller may be configured to determine that the reflections are received from an object moving across and displaced from the surface, and illuminate one or more indicator lines to identify a physical location of one of the charging areas available to wirelessly charge a chargeable device.

In some instances, the controller is further configured to detect a doppler shift in the reflections with respect to the signal transmitted by the at least one wireless transmitter. The controller may be further configured to determine presence or movement of the object based on the doppler shift.

In some instances, the controller is further configured to triangulate reflections of signals transmitted by multiple wireless transmitters and determine presence of the object based on triangulation.

In one example, the signal transmitted by the at least one wireless transmitter includes an infrared signal. In another example, the signal transmitted by the at least one wireless transmitter includes an acoustic signal. In another example, the signal transmitted by the at least one wireless transmitter includes a radio frequency signal.

Some implementation examples are described in the following numbered clauses:
1. A method for detecting an object, comprising: conducting a low-power search of a surface to determine if an electrical or magnetic characteristic of two or more power transmitting coils has been affected by an object passing in proximity to the two or more power transmitting coils; determining a geometric relationship between physical locations of the two or more power transmitting coils; and illuminating one or more indicator lines to identify a physical location of a charging area available to wirelessly charge a chargeable device, the charging area being selected based on the geometric relationship between physical locations of the two or more power transmitting coils.
2. The method as described in clause 1 or clause 2, wherein conducting the low-power search comprises: providing a pulsed signal to each of a plurality of power transmitting coils, wherein each pulse in the pulsed signal comprises a plurality of cycles of a clock signal; and detecting a change in resonance associated with each of the two or more power transmitting coils based on response to the pulsed signal.
3. The method as described in clause 1 or clause 2, wherein changes in the electrical or magnetic characteristic are detected in three or more power transmitting coils, and wherein the three or more power transmitting coils are located along a substantially straight line.
4. The method as described in clause 1 or clause 2, wherein changes in the electrical or magnetic characteristic are detected in three or more power transmitting coils, and wherein the three or more power transmitting coils are located along an arc of an ellipse or circle.
5. The method as described in any of clauses 1-4, wherein changes in the electrical or magnetic characteristic comprise a change in capacitance in a resonant circuit.
6. The method as described in any of clauses 1-5, wherein changes in the electrical or magnetic characteristic associated with the two or more power transmitting coils occur when the chargeable device is moved across and displaced from a surface of a countertop or table.
7. The method as described in clause 6, wherein one or more charging areas are embedded in the surface of a countertop or table.
8. The method as described in clause 6, wherein one or more charging areas are located under the surface of a countertop or table.
9. A charging system, comprising: a charging surface comprising one or more charging areas associated with a wireless charging device; a plurality of power transmitting coils apportioned among the one or more charging areas; and a controller configured to: conduct a low-power search of the charging surface to determine if an electrical or magnetic characteristic of two or more power transmitting coils has been affected by an object passing in proximity to the two or more power transmitting coils; determine a geometric relationship between physical locations of the two or more power transmitting coils; and illuminate one or more indicator lines to identify a physical location of a charging area available to wirelessly charge a chargeable device, the physical location being selected based on the geometric relationship between physical locations of the two or more power transmitting coils.
10. The charging system as described in clause 9, wherein the controller is further configured to: provide a pulsed signal to each of a plurality of power transmitting coils when conducting the low-power search, wherein each pulse in the pulsed signal comprises a plurality of cycles of a clock signal; and detect a change in resonance associated with each of the two or more power transmitting coils based on response to the pulsed signal.
11. The charging system as described in clause 9 or clause 10, wherein changes in the electrical or magnetic characteristic are detected in three or more power transmitting coils, and wherein the three or more power transmitting coils are located along a substantially straight line.
12. The charging system as described in any of clauses 9-10, wherein changes in the electrical or magnetic characteristic are detected in three or more power transmitting coils, and wherein the three or more power transmitting coils are located along an arc of an ellipse or circle.
13. The charging system as described in any of clauses 9-12, wherein changes in the electrical or magnetic characteristic comprise a change in capacitance in a resonant circuit.
14. The charging system as described in any of clauses 9-13, wherein changes in the electrical or magnetic characteristic associated with the two or more power transmitting coils occur when the chargeable device is moved across and displaced from a surface.
15. The charging system as described in any of clauses 9-14, further comprising: charging modules, each associated with a corresponding charging area and coupled to, or embedded in a surface of a countertop or table.
16. A charging system, comprising: a charging surface comprising one or more charging areas associated with a wireless charging device; one or more wireless transmitters; one or more wireless receivers configured to receive reflections of a signal transmitted by at least one wireless transmitter; and a controller configured to: determine that the reflections are received from an object moving across and displaced from the charging surface; and illuminate one or more indicator lines to identify a physical location of one of the charging areas available to wirelessly charge a chargeable device.
17. The charging system as described in clause 16, wherein the controller is further configured to: detect a doppler shift in the reflections with respect to the signal transmitted by the at least one wireless transmitter; and determine presence or movement of the object based on the doppler shift.
18. The charging system as described in clause 16 or clause 17, wherein the controller is further configured to: triangulate reflections of signals transmitted by multiple wireless transmitters; and determine presence of the object based on triangulation.
19. The charging system as described in any of clauses 16-18, wherein the signal transmitted by the at least one wireless transmitter comprises an infrared signal or acoustic signal.
20. The charging system as described in any of clauses 16-18, wherein the signal transmitted by the at least one wireless transmitter comprises a radio frequency signal.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, whereby reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for detecting an object, comprising:
conducting a low-power search of a surface to determine if an electrical or magnetic characteristic of two or more power transmitting coils has been affected by an object passing in proximity to the two or more power transmitting coils;
determining a geometric relationship between physical locations of the two or more power transmitting coils; and
illuminating one or more indicator lines to identify a physical location of a charging area available to wirelessly charge a chargeable device, the charging area being selected based on the geometric relationship between physical locations of the two or more power transmitting coils.

2. The method of claim 1, wherein conducting the low-power search comprises:
providing a pulsed signal to each of a plurality of power transmitting coils, wherein each pulse in the pulsed signal comprises a plurality of cycles of a clock signal; and
detecting a change in resonance associated with each of the two or more power transmitting coils based on response to the pulsed signal.

3. The method of claim 1, wherein changes in the electrical or magnetic characteristic are detected in three or more power transmitting coils, and wherein the three or more power transmitting coils are located along a substantially straight line.

4. The method of claim 1, wherein changes in the electrical or magnetic characteristic are detected in three or more power transmitting coils, and wherein the three or more power transmitting coils are located along an arc of an ellipse or circle.

5. The method of claim 1, wherein changes in the electrical or magnetic characteristic comprise a change in capacitance in a resonant circuit.

6. The method of claim 1, wherein changes in the electrical or magnetic characteristic associated with the two or more power transmitting coils occur when the chargeable device is moved across and displaced from a surface of a countertop or table.

7. The method of claim 6, wherein one or more charging areas are embedded in the surface of a countertop or table.

8. The method of claim 6, wherein one or more charging areas are located under the surface of a countertop or table.

9. A charging system, comprising:
a charging surface comprising one or more charging areas associated with a wireless charging device;
a plurality of power transmitting coils apportioned among the one or more charging areas; and
a controller configured to:
conduct a low-power search of the charging surface to determine if an electrical or magnetic characteristic of two or more power transmitting coils has been affected by an object passing in proximity to the two or more power transmitting coils;
determine a geometric relationship between physical locations of the two or more power transmitting coils; and
illuminate one or more indicator lines to identify a physical location of a charging area available to wirelessly charge a chargeable device, the physical location being selected based on the geometric relationship between physical locations of the two or more power transmitting coils.

10. The charging system of claim 9, wherein the controller is further configured to:
provide a pulsed signal to each of a plurality of power transmitting coils when conducting the low-power search, wherein each pulse in the pulsed signal comprises a plurality of cycles of a clock signal; and
detect a change in resonance associated with each of the two or more power transmitting coils based on response to the pulsed signal.

11. The charging system of claim 9, wherein changes in the electrical or magnetic characteristic are detected in three or more power transmitting coils, and wherein the three or more power transmitting coils are located along a substantially straight line.

12. The charging system of claim 9, wherein changes in the electrical or magnetic characteristic are detected in three or more power transmitting coils, and wherein the three or more power transmitting coils are located along an arc of an ellipse or circle.

13. The charging system of claim 9, wherein changes in the electrical or magnetic characteristic comprise a change in capacitance in a resonant circuit.

14. The charging system of claim 9, wherein changes in the electrical or magnetic characteristic associated with the two or more power transmitting coils occur when the chargeable device is moved across and displaced from a surface.

15. The charging system of claim 9, further comprising:
charging modules, each associated with a corresponding charging area and coupled to, or embedded in a surface of a countertop or table.

16. A charging system, comprising:
a charging surface comprising one or more charging areas associated with a wireless charging device;
one or more wireless transmitters;
one or more wireless receivers configured to receive reflections of a signal transmitted by at least one wireless transmitter; and
a controller configured to:
determine that the reflections are received from an object moving across and displaced from the charging surface; and
illuminate one or more indicator lines to identify a physical location of one of the charging areas available to wirelessly charge a chargeable device.

17. The charging system of claim 16, wherein the controller is further configured to:
detect a doppler shift in the reflections with respect to the signal transmitted by the at least one wireless transmitter; and
determine presence or movement of the object based on the doppler shift.

18. The charging system of claim 16, wherein the controller is further configured to:
triangulate reflections of signals transmitted by multiple wireless transmitters; and
determine presence of the object based on triangulation.

19. The charging system of claim 16, wherein the signal transmitted by the at least one wireless transmitter comprises an infrared signal or acoustic signal.

20. The charging system of claim 16, wherein the signal transmitted by the at least one wireless transmitter comprises a radio frequency signal.
